(19) United States
(12) Patent Application Publication
(10) Pub. No.: US 2025/0086727 A1
(43) Pub. Date: Mar. 13, 2025

(54) ARTIFICIAL INTELLIGENCE ASSISTANT FOR INVESTIGATIVE QUESTIONING

(71) Applicant: Peggy Saldana, San Antonio, TX (US)

(72) Inventor: Peggy Saldana, San Antonio, TX (US)

(21) Appl. No.: 18/828,117

(22) Filed: Sep. 9, 2024

Related U.S. Application Data
(60) Provisional application No. 63/537,072, filed on Sep. 7, 2023.

(51) Int. Cl. G06Q 40/08; G10L 15/18; G10L 15/26

(52) U.S. Cl. CPC G06Q 40/08; G10L 15/1815; G10L 15/26

(57) ABSTRACT

There is disclosed a computer-implemented system and method for providing an artificial intelligence assistant for investigative questioning, including, based on known information about an event under investigation, accessing a generative artificial intelligence (GAI) trained to generate investigative question prompts to guide a human investigator, wherein the investigative question prompts are to assist the human investigator in asking probative and open-ended questions of a human participant in, or witness to, the event under investigation; and interactively displaying, on a computer display, the investigative question prompts to the human investigator during the course of an interview.

### CROSS REFERENCE TO RELATED APPLICATION

This application claims priority to U.S. Provisional Application 63/537,072, titled “Large Language Model for Insurance Investigation,” filed Sep. 7, 2023, which is incorporated herein by reference.

### Field of the Specification

This application relates in general to fraud mitigation, and more particularly though not exclusively to an artificial intelligence assistant for insurance investigation.

### BACKGROUND

Insurance companies indemnify policy holders in case of accidents. Insurance companies are legally and contractually obligated to pay valid claims. However, it is beneficial to both the insurance company and its customer base to not pay fraudulent or overstated claims. To this end, insurance companies employ investigators who are tasked with determining, to the greatest extent possible, the true events of an accident and which party or parties are liable.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of an investigative ecosystem.

FIG. 2 is a block diagram of selected elements of a device ecosystem.

FIG. 3 is a block diagram of selected elements of an offline field device.

FIG. 4 is a block diagram of selected elements of an online field device.

FIG. 5 is a block diagram of selected elements of a cloud service.

FIG. 6 is a block diagram illustration of an example collision.

FIG. 7 is a flow chart of selected elements of preparing a field device.

FIG. 8 is a flow chart of selected elements of conducting an investigation.

FIG. 9 is a block diagram illustration of an example field device GUI.

FIG. 10 is a block diagram of selected elements of a hardware platform.

FIG. 11 is a block diagram of selected elements of a network function virtualization (NFV) infrastructure.

FIG. 12 is a block diagram of selected elements of a containerization infrastructure.

FIG. 13 illustrates machine learning according to a “textbook” problem with real-world applications.

FIG. 14 is a flowchart of a method that may be used to train a neural network.

FIG. 15 is a flowchart of a method of using a neural network to classify an object.

FIG. 16 is a block diagram illustrating selected elements of an analyzer engine.

### SUMMARY

There is disclosed a computer-implemented system and method for providing an artificial intelligence assistant for investigative questioning, including, based on known information about an event under investigation, accessing a generative artificial intelligence (GAI) trained to generate investigative question prompts to guide a human investigator, wherein the investigative question prompts are to assist the human investigator in asking probative and open-ended questions of a human participant in or witness to the event under investigation; and interactively displaying, on a computer display, the investigative question prompts to the human investigator during the course of an interview.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

The present specification describes a system and method for providing artificial intelligence (AI) assistance to a human investigator during her investigation of an incident. An illustrative use case includes an insurance investigator investigating a vehicle accident. The insurance investigator is aided by AI models such as a generative AI (GAI), e.g., a large language model (LLM). Other AI services such as a “digital eye” may be used to examine photographs, diagrams, and other evidence related to the incident. In the illustrative use case, the GAI provides real-time or near real-time prompts to the insurance investigator to help her ask probative questions designed to adduce valuable information related to the actual circumstances of the accident. While insurance investigation is used as an example to teach the methods of the present specification, the teachings herein can also be applied to other fields of endeavor, such as medical or legal malpractice, maritime incidents, Federal Aviation Administration (FAA) investigations, police investigations, detectives (private or public), intelligence gathering, military or intelligence debriefings, interrogations, job interviews, attorney depositions, or other evidence synthesis for litigation, to name only a few examples.

In the case of investigating an insurance event, the event may be any insured event, including by way of illustrative and nonlimiting example, a single-car accident, a multiple-car accident, a pedestrian-involved car accident, an insured retail loss (e.g., from theft, spoilage, weather damage to vehicles, or other cause), a structural loss (e.g., damage to a home or business from natural disasters, riots, looting, or other causes), or a worker's compensation event (e.g., from a workplace injury). The teachings herein may also be used to aid an attorney in prepping for a deposition (in which case, a real-time transcript may not be used) or in conducting a deposition (which may involve a real-time transcript). The teachings herein may also be used in a military context, such as in interviewing participants for a post-action report of an engagement or interviewing or interrogating enemy combatants or prisoners. The teachings herein may also be used to aid an investigating officer or detective in interviewing witnesses to a crime or incident. The teachings may also be used to aid officers and detectives in interrogating suspects. Other uses will also be readily evident, particularly in any case where an interview is intended to adduce information, wherein asking open-ended and probative questions is valuable.

Throughout this specification, an insurance investigator investigating a two-vehicle accident will be used to illustrate principles of the disclosed method. The use of this example is not intended to exclude any other kind of interview or questioning from the scope of the present disclosure.

In an illustrative example, an insurance carrier receives a “first notice of loss” (FNOL), or in other words a first report from an insured that a covered event has occurred (e.g., a car accident). A preliminary matter may be to analyze the FNOL to route the case to an appropriate adjuster or investigator. In many cases, the insured may contact the carrier immediately after the accident, even while still at the scene. Depending on the accident, police investigators may also be involved. In one use case, the police investigator may be aided by an AI assistant as described in the specification. The AI assistant may aid the investigating officer in asking appropriate and probative questions, which may provide a higher quality initial investigation.

In some cases, if the insured driver is talking to the insurance carrier reporting the FNOL at the accident scene, the investigating officer may request the insured driver to quickly end the call and participate in the officer's investigation. In that case, the person or system receiving the FNOL may ask a small number of preliminary questions, such as five questions, to gather critical data that can be used to route the investigation. For example, the insurer may ask the insured driver to verify the date of the accident, time of the accident, location of the accident, name and badge number of the investigating officer (if available), the names of the parties (if known), and if anybody appears to be seriously injured. Thereafter, it may be a goal for the appropriate investigator to contact the insured driver and perform her investigation within a relatively short time, such as within 48 hours.

FNOL may be initiated by either driver (e.g., the carrier's insured, or the other vehicle, calling as a claimant). If the insured calls first, the carrier may first determine if the insured has collision coverage appropriate to the circumstances. If so, the insured may have the option to file with the carrier, subject for example to a deductible, pending a determination of liability. In this case, the AI Assistant may provide prompts appropriate to the FNOL investigation, and may also provide a list of preferred body shops, along with a notice that the insured is free to use the body shop of his choice. If the insured needs a rental, the prompts may provide instructions for procuring a rental, including preferred providers.

If the claimant calls first (e.g., claiming the insured driver was at fault), the AI assistant may provide prompts that, for example, encourage the claimant to file first with his own carrier pending the investigation (as the carrier usually will not pay out to the claimant until liability is established).

In either case, the AI assistant may prompt the agent taking the FNOL to collect vital case data, including verifying the date and time of the accident, location of the accident, names and phone numbers of the parties (insured and claimant), and name and badge number of the investigating officer (if any). These high-priority vital data about the incident may be sufficient to route the case to an appropriate investigator, who can gather further evidence and information.

In an example accident, the claimant vehicle (CV) is making a legal but unprotected (i.e., no green turn arrow) left turn, facing north. The insured vehicle (IV) is southbound in the right lane. The insured driver (ID) knows that the light will turn red soon, so he presses the gas to make the light. The claimant driver (CD) does not see the IV because there is a city bus in the southbound left lane. The CD thinks the intersection is clear and turns left, and is hit by the IV.

Generally speaking, a motor vehicle accident is a tort, and the basic elements of a tort are (1) duty, (2) breach of duty, (3) proximate cause, and (4) harm. The investigation may be concerned with who owed a duty to whom (often both parties owed duties to one another), who breached that duty (again, it is often both parties), was the breach of duty a proximate cause of damage, and how are those damages quantified?

Before the investigator begins her initial investigation into this accident, the AI assistant may receive relevant data to prepare a package of visual aids, prompts, or other information for the ID. For example, if a police report has been filed before the investigation commences, and if the police report is available to the carrier, then the LLM may read the police report, and provide a digest of relevant facts that may be readily available to the investigator. The system may also receive a reported location of the incident and provide aids such as a localized map via geographical information systems (GIS) databases. In an example of a two-vehicle accident, a software service may provide a graphical user interface (GUI) that displays with high locality (e.g., with a radius of approximately 100 m or less) the road structures, traffic control elements, intersections, lanes, and other information associated with the situs of the accident. The software may also provide an overlay on top of the map, such as graphical representations of the vehicles and/or people involved in the accident, which can be moved on a touchscreen or monitor display, using a mouse, finger, stylus, or other input device, to model the movement of the vehicles and the point of collision. Users may also be able to sketch on the provided map to illustrate information about the accident.

The investigator may take her field device with her as she interviews the parties to the accident. The field device may include the GUI described above, on which the parties can sketch out what happened where. The field device will also access an AI assistant to aid the investigator in asking open-ended, probative questions designed to elicit the genuine facts of the case.

Based on photographic evidence and the interviews, the investigator may determine that the point of impact on the IV is the left front light, hood, and fender. The point of impact for the CV is the right front fender. The investigator, with the aid of prompts from the AI assistant, may also elicit the facts of the case from the two drivers, who will then have difficulty changing their stories later. Based on the interviews and the photographic evidence, the investigator determines that neither vehicle had clear control of the intersection, thus the CD (who was making an unprotected left turn) had a greater duty to yield to southbound traffic (e.g., the southbound IV). However, given the limited visibility and the failure to reduce speed upon entering the intersection, the ID was not driving defensively. The investigator may thus determine that the ID was 5% negligent for failing to defensively keep a proper lookout (despite having the right of way), and 10% negligent for failing to reduce speed upon entering the intersection (despite having a green light). Thus, the CD is 85% negligent and the ID is 15% negligent.

Taking Texas as an example, a party that is more negligent than the other party cannot collect damages (the so-called “51% rule”). Thus, CD should not be able to collect from ID's carrier, and instead the carrier should collect from CD's carrier. The damages awarded to ID will (theoretically) be reduced by 15% to account for ID's comparative negligence.

Naturally, the carrier's investigation does not, by itself, carry the weight of law. However, police investigators rarely apportion liability themselves, preferring to leave the unpleasant task to insurance companies. And absent evidence to the contrary (e.g., statements, physical evidence admissions, police reports, or other), insurers generally have an obligation to, and interest in, defending their insureds from liability claims. In litigation of a civil matter, a jury must assign liability by a preponderance of the evidence. So, this comparative negligence determination, based on a sound investigation aided by an AI assistant that provides question prompts, will form a guideline for establishing a strong, fact-based case for liability.

Capturing high quality and factual information early in the case may be highly valuable to a successful insurance investigation. The insurance carrier is required by law and by contract in most jurisdictions to pay out on valid insurance claims. However, some less scrupulous parties to an incident may see an insured event as a free payday or an invitation to seek compensation they are not genuinely owed. Furthermore, some less scrupulous attorneys or other representatives may pressure a participant in an incident to modify his story to maximize his damages while minimizing his apparent liability. For example, the foregoing ID may be motivated to later claim that he slowed down when approaching the intersection, or the CD may be motivated to later claim that the ID was driving erratically, and that he (the CD) was already in the intersection when the ID sped up. Such modified claims are harder to make when they are (1) inconsistent with earlier statements, and (2) inconsistent with physical and documentary evidence.

Understanding not only the facts, but the law that governs an accident, is also important. For example, US jurisdictions have very different shared liability regimens. In “pure comparative negligence” jurisdictions, either party is permitted to recover damages, mitigated by his share of liability. For example, Party A suffers $1000 in damages and is only 30% liable. However, Party B is 70% liable and has $10,000 in damages. In that case, Party A would receive $700 in damages from Party B, while Party B would receive $3000 in damages from Party A, with a net payment of $2300 to Party B. Pure comparative negligence is the law in only a small minority of states.

In a different small minority of states, the law enforces strict “contributory negligence.” In those states, a party that has any contributory negligence (even as little as 0.1%) cannot collect from the other party.

Most states have some version of “modified comparative negligence,” with either a 50% bar rule, or a 51% bar rule. With a 50% bar rule, if the parties are equally responsible, neither can collect damages from the other. With a 51% bar rule, only the party that is less at fault can collect damages from the other.

In addition to the complexities of different states having different liability regimens, many venues, localities, states, communities, and other jurisdictions will have their own traffic laws and regulations. Thus, an act that may be considered negligent in one jurisdiction because it is contrary to the traffic laws of that jurisdiction may not be negligent in another jurisdiction.

In theory, liability is determined by taking the facts of the case, which should be independent of the jurisdiction because those facts simply represent what happened, and then applying the law of the jurisdiction to those facts to determine. Thus, the same set of genuine facts may yield a different liability determination in different jurisdictions.

In reality, as the implications of liability and ramifications of behavior become clear later in the case, some parties and their counsel may feel inherent pressure to mold the facts of the case to the laws of the jurisdiction. For example, if the foregoing accident were to occur in Maryland, the ID may hesitate to admit that he accelerated into the intersection, once he realizes or learns that Maryland is a strict contributory negligence state. Such modifications need not be deliberately or willfully dishonest. It is human nature that when a person feels exposed to blame or liability, he will (deliberately or subconsciously) reshape facts within his own mind to limit his faults.

However, insurance carriers have an interest in ascertaining the legitimate facts of the case early on, before people have time to reshape their stories (either deliberately or subconsciously). Thus, value is found in ensuring that a high-quality investigation is completed in the first instance. In an ideal world, the insurance investigator would be able to be on scene at the accident to take photographs, interview parties, interview third-party witnesses, and determine liability before anybody even leaves. In reality, this is rarely practical for many insurance investigators (FNOL may not even occur until after everybody has left). So, investigators may need to rely on information such as police reports, police interviews of third-party witnesses, and statements of the parties taken by police at the scene, as well as statements given to the investigator shortly after the incident (e.g. within about 48 hours). Again, ideally the investigator will be able to speak to both the ID and the CD. However, there are instances where the CD is unwilling to speak to the insurance investigator, in which case the investigator may need to get information from the CD's insurance carrier.

Furthermore, skilled investigators may have as many as 200 cases per month, and many will need to cross jurisdictions (e.g., state lines) to investigate different cases. It is not practical for a human being to keep at her fingertips not only the facts of all these many cases, but also the laws, regulations, and idiosyncrasies of multiple jurisdictions. Furthermore, the investigator may need to explain to the insured the laws and facts of the case in an understandable way.

In one example, the CD is stopped at a red light. The roads are slick with rain, ID fails to brake in time, and the IV rear-ends the CV. At the scene, the investigating officer does not ticket either party for the accident but tickets the CD for not having insurance. After the insurer has elicited these facts, the ID may demand that the carrier not pay the CD's damage claim, because “He's the only one who got a ticket at the scene.” In that case, the investigator may need to explain to the (possibly angry or agitated) ID on the phone that the other driver's failure to procure proper insurance is immaterial to fault in the accident, and based on the available facts, the ID is 100% at fault. (An AI assistant can also be helpful in handling these kinds of conversations.)

These complexities increase the importance of ensuring that high-quality investigations are performed, including asking high-quality, open-ended, probative questions that will elicit valid information without leading the party or witness.

To aid the insurance investigator, the present specification describes a field device, such as a tablet computer, laptop computer, personal digital assistant (PDA), smartphone, convertible tablet, or similar. This may be a device that an investigator takes with her for the investigation. Two species of field devices are illustrated in the specification. In a first case, the field device is expected to have internet connectivity throughout the investigation. In that case, the field device may access cloud services such as a cloud-based GAI, cloud-based image scanning, GIS databases, weather, news, traffic, and other information. In an offline example of a field device, the investigation may occur in a location where reliable network access is not available. In that case, the field device may be preloaded with available information, such as local maps, a local version of a digital eye, and a modified version of the LLM that is this typically lighter weight and specifically configured to provide guidance in the investigation.

In an illustrative use example, the investigator takes the preloaded field device to the site of an interview. The investigator interviews the party or witness, including by referencing a display on which the GAI provides prompts or recommended questions to guide the interview. This novel human-machine partnership enables the human investigator to bring a human element into the investigation, while also providing the robust knowledge of machine learning. The insured or claimant is not forced to interact with an uncanny chatbot or other pure AI interface. However, experience has shown that even very good investigators sometimes fall into the trap of asking low-quality questions, especially closed-ended questions. For example, if the investigator asks the party “Were you speeding,” the natural human instinct to shield oneself from blame will lead most people to answer “no,” or perhaps “not really,” or “not by more than a mile or two per hour.”

On the other hand, if the investigator asks a party, “Go back in time 10 seconds before the accident. What speed were you traveling?” In this case, the party is much more likely to give an informative answer. If the party does not have an immediate knowledge of the speed limit on that particular road, then he may in fact admit to speeding without even knowing it. Whether the person being interviewed is the insured or the claimant, this will yield valuable information that will help the investigator more correctly determine who is genuinely at fault, and to what degree.

In almost every instance, asking open-ended questions and giving the party an opportunity to simply tell the story will yield better, more complete, and more correct information than asking closed and/or challenging questions. Furthermore, gathering this information early in the process may ensure that the testimony is temporally proximate to the incident when memories are fresh, rather than when time and circumstances have had a chance to taint or adjust memories.

An LLM may be trained with both prompts and an input database. The prompt may be in a natural human language format, as follows:
[Input: Insurance investigation best practices]
[Input: Exemplar transcripts of good conversations]
[Input: Copy of police report]
[Input: Image-to-text description of photographs taken at the scene]
[Input: Statements from the FNOL]
[Input: AI-generated digest of reported traffic conditions]
[Input: AI-generated digest of reported weather conditions]
[Input: Image-to-text conversion output. Textual description of the scene of the accident, including layout and estimated distances.]

Your task is to assist an insurance investigator with carrying out an investigation of an automobile accident. The goal of the investigation is to determine which party is at fault in the accident, or if both parties are partially responsible, and approximately what percentage each party is liable.

You have been provided with several inputs. These include:
1. A document describing insurance investigation best practices
2. A large set of transcripts that represent “good” (but not always perfect) insurance investigations
3. A copy of the police report
4. A description of photographs taken at the scene, generated by an image-to-text AI
5. A description of photographs taken at the scene, provided by a text-to-image AI
6. A transcription of the FNOL
7. An AI-generated digest of reported traffic conditions
8. An AI-generated digest of reported weather conditions
9. A description of the geography and layout of the accident scene, from a text-to-image AI

You will now receive a real-time text-to-speech transcript of a conversation between the insurance investigator and at least one other person who is a party or witness to the accident. After each utterance from the other party or parties, provide a brief prompt for a suggested follow-up question to develop the information given or to adduce new information. Questions should usually be open-ended.

Your prompts do not need to be conversational; the human will handle that.

The transcription AI will identify, to the best of its ability, who is speaking when, but you should also use context clues as appropriate. The transcription AI will listen for tone and vocal cues to identify indicia of stress, strain, deceit, hostility, nervousness, or other shifts in mood. It will provide these as hints within square brackets [ ] in the transcription. Remember that this AI is fallible, so use context clues to adjust as necessary.

The conversation should be non-confrontational where possible.

The investigator can provide feedback in the form of a thumbs-down. If you receive a thumbs-down, the investigator thinks the proposed question is a bad question. In that case, try a different question. If the investigator asks a question different from the one you suggest, integrate the new information and either suggest the question again or suggest a new question, as appropriate.

An LLM can be pre-trained on this prompt, can be given training transcripts to illustrate good questioning techniques, and can receive inputs from various databases. In cases where a field device may be out of communication, a lower-resolution version of this LLM may be stored locally on the device. In cases where connectivity is not expected to be an issue, the full-resolution version of the LLM can be hosted in a cloud service, and can guide the conversation.

### Selected Examples

The foregoing can be used to build or embody several example implementations, according to the teachings of the present specification. Some example implementations are included here as nonlimiting illustrations of these teachings.

Example 1 includes one or more tangible, nontransitory computer-readable storage media having stored thereon executable instructions to instruct one or more processors to: based on known information about an event under investigation, access a generative artificial intelligence (GAI) trained to generate investigative question prompts to guide a human investigator, wherein the investigative question prompts are to assist the human investigator in asking probative and open-ended questions of a human participant in or witness to the event under investigation; and interactively display the investigative question prompts to the human investigator during the course of an interview.

Example 2 includes the one or more tangible, nontransitory computer-readable storage media of example 1, wherein the event under investigation is an insurance event.

Example 3 includes the one or more tangible, nontransitory computer-readable storage media of example 2, wherein the insurance event comprises an automobile accident.

Example 4 includes the one or more tangible, nontransitory computer-readable storage media of example 2, wherein the insurance event comprises a worksite accident.

Example 5 includes the one or more tangible, nontransitory computer-readable storage media of example 2, wherein the insurance event comprises a retail loss.

Example 6 includes the one or more tangible, nontransitory computer-readable storage media of example 2, wherein the insurance event comprises a structural loss from a natural disaster or social unrest.

Example 7 includes the one or more tangible, nontransitory computer-readable storage media of example 1, wherein the instructions are further to incorporate geographic information system (GIS) knowledge into the investigative question prompts.

Example 8 includes the one or more tangible, nontransitory computer-readable storage media of example 1, wherein the instructions are further to incorporate weather condition knowledge into the investigative question prompts.

Example 9 includes the one or more tangible, nontransitory computer-readable storage media of example 1, wherein the instructions are further to incorporate traffic condition knowledge into the investigative question prompts.

Example 10 includes the one or more tangible, nontransitory computer-readable storage media of example 1, wherein the instructions are further to operate an AI system to create a digest of previous information about the event under investigation, and incorporate the digest into the investigative question prompts.

Example 11 includes the one or more tangible, nontransitory computer-readable storage media of example 10, wherein the previous information comprises a police report.

Example 12 includes the one or more tangible, nontransitory computer-readable storage media of example 10, wherein the previous information comprises a first notice of loss.

Example 13 includes the one or more tangible, nontransitory computer-readable storage media of example 1, wherein the instructions are further to provide an interactive display for the human investigator.

Example 14 includes the one or more tangible, nontransitory computer-readable storage media of example 13, wherein the interactive display includes a map of a situs of the event under investigation, wherein the map is based on geographic information system (GIS) data.

Example 15 includes the one or more tangible, nontransitory computer-readable storage media of example 13, wherein the interactive display includes images with a human markup capability.

Example 16 includes the one or more tangible, nontransitory computer-readable storage media of example 1, wherein the instructions are further to transcribe a verbal conversation between the human investigator and the human participant, and adjust the investigative question prompts based on the transcribing.

Example 17 includes the one or more tangible, nontransitory computer-readable storage media of example 16, wherein the instructions are further to recognize a voice of the human investigator, and separate utterances of the human investigator from other utterances.

Example 18 includes the one or more tangible, nontransitory computer-readable storage media of example 16, wherein the instructions are further to recognize language and/or non-language indicia of sentiment, and provide a transcript that includes the indicia of sentiment.

Example 19 includes the one or more tangible, nontransitory computer-readable storage media of example 16, wherein the instructions are further to recognize non-language indicia of sentiment, wherein the indicia of sentiment include at least one of an indicium of stress, strain, deceit, hostility, fear, anger, or cooperativeness.

Example 20 includes the one or more tangible, nontransitory computer-readable storage media of any of examples 1-15, wherein the GAI comprises a large language model (LLM) or generative pre-trained transformer (GPT).

Example 21 includes a computer-implemented method, comprising: based on known information about an event under investigation, accessing a generative artificial intelligence (GAI) trained to generate investigative question prompts to guide a human investigator, wherein the investigative question prompts are to assist the human investigator in asking probative and open-ended questions of a human participant in, or witness to, the event under investigation; and interactively displaying, on a computer display, the investigative question prompts to the human investigator during the course of an interview.

Example 22 includes the computer-implemented method of example 21, wherein the event under investigation is an insurance event.

Example 23 includes the computer-implemented method of example 22, wherein the insurance event comprises an automobile accident.

Example 24 includes the computer-implemented method of example 22, wherein the insurance event comprises a worksite accident.

Example 25 includes the computer-implemented method of example 22, wherein the insurance event comprises a retail loss.

Example 26 includes the computer-implemented method of example 22, wherein the insurance event comprises a structural loss from a natural disaster or social unrest.

Example 27 includes the computer-implemented method of example 21, further comprising incorporating geographic information system (GIS) knowledge into the investigative question prompts.

Example 28 includes the computer-implemented method of example 21, further comprising incorporating weather condition knowledge into the investigative question prompts.

Example 29 includes the computer-implemented method of example 21, further comprising incorporating traffic condition knowledge into the investigative question prompts.

Example 30 includes the computer-implemented method of example 21, further comprising operating an AI system to create a digest of previous information about the event under investigation, and incorporate the digest into the investigative question prompts.

Example 31 includes the computer-implemented method of example 30, wherein the previous information comprises a police report.

Example 32 includes the computer-implemented method of example 30, wherein the previous information comprises a first notice of loss.

Example 33 includes the computer-implemented method of example 21, further comprising providing an interactive display for the human investigator.

Example 34 includes the computer-implemented method of example 33, wherein the interactive display includes a map of a situs of the event under investigation, wherein the map is based on geographic information system (GIS) data.

Example 35 includes the computer-implemented method of example 33, wherein the interactive display includes images with a human markup capability.

Example 36 includes the computer-implemented method of example 21, further comprising transcribing a verbal conversation between the human investigator and the human participant, and adjusting the investigative question prompts based on the transcribing.

Example 37 includes the computer-implemented method of example 36, further comprising recognizing a voice of the human investigator, and separating utterances of the human investigator from other utterances.

Example 38 includes the one or more tangible, nontransitory computer-readable storage media of example 16, further comprising recognizing language and/or non-language indicia of sentiment, and providing a transcript that includes the indicia of sentiment.

Example 39 includes the method of example 21, further comprising recognizing non-language indicia of sentiment, wherein the indicia of sentiment include at least one of an indicium of stress, strain, deceit, hostility, fear, anger, or cooperativeness.

Example 40 includes the method of any of examples example 21-39, wherein the GAI comprises a large language model (LLM) or generative pre-trained transformer (GPT).

Example 41 includes the apparatus comprising means for performing the method of any of examples 21-40.

Example 42 includes the apparatus of example 41, wherein the means for performing the method comprise a processor and a memory.

Example 43 includes the apparatus of example 42, wherein the memory comprises machine-readable instructions that, when executed, cause the apparatus to perform the method of any of examples 21-40.

Example 44 includes the apparatus of any of examples 41-43, wherein the apparatus is a computing system.

Example 45 includes at least one computer-readable medium comprising instructions that, when executed, implement a method or realize an apparatus as in any of examples 21-44.

Example 46 includes a field device for an investigator, comprising: a hardware platform comprising a processor circuit, a memory, and an interactive display device; and instructions encoded within the memory to instruct the processor circuit to: based on known information about an event under investigation, access a generative artificial intelligence (GAI) trained to generate investigative question prompts to guide a human investigator, wherein the investigative question prompts are to assist the human investigator in asking probative and open-ended questions of a human participant in, or witness to, the event under investigation; and display, via the interactive display device, the investigative question prompts to the human investigator during the course of an interview.

Example 47 includes the field device of example 46, wherein the event under investigation is an insurance event.

Example 48 includes the field device of example 47, wherein the insurance event comprises an automobile accident.

Example 49 includes the field device of example 47, wherein the insurance event comprises a worksite accident.

Example 50 includes the field device of example 47, wherein the insurance event comprises a retail loss.

Example 51 includes the field device of example 47, wherein the insurance event comprises a structural loss from a natural disaster or social unrest.

Example 52 includes the field device of example 46, wherein the instructions are further to incorporate geographic information system (GIS) knowledge into the investigative question prompts.

Example 53 includes the field device of example 46, wherein the instructions are further to incorporate weather condition knowledge into the investigative question prompts.

Example 54 includes the field device of example 46, wherein the instructions are further to incorporate traffic condition knowledge into the investigative question prompts.

Example 55 includes the field device of example 46, wherein the instructions are further to operate an AI system to create a digest of previous information about the event under investigation, and incorporate the digest into the investigative question prompts.

Example 56 includes the field device of example 55, wherein the previous information comprises a police report.

Example 57 includes the field device of example 55, wherein the previous information comprises a first notice of loss.

Example 58 includes the field device of example 46, wherein the instructions are further to provide an interactive display for the human investigator.

Example 59 includes the field device of example 58, wherein the interactive display includes a map of a situs of the event under investigation, wherein the map is based on geographic information system (GIS) data.

Example 60 includes the field device of example 58, wherein the interactive display includes images with a human markup capability.

Example 61 includes the field device of example 46, wherein the instructions are further to transcribe a verbal conversation between the human investigator and the human participant, and adjust the investigative question prompts based on the transcribing.

Example 62 includes the field device of example 61, wherein the instructions are further to recognize a voice of the human investigator, and separate utterances of the human investigator from other utterances.

Example 63 includes the field device of example 61, wherein the instructions are further to recognize language and/or non-language indicia of sentiment, and provide a transcript that includes the indicia of sentiment.

Example 64 includes the field device of example 46, wherein the instructions are further to recognize non-language indicia of sentiment, wherein the indicia of sentiment include at least one of an indicium of stress, strain, deceit, hostility, fear, anger, or cooperativeness.

Example 65 includes the field device of example 46, wherein the GAI comprises a large language model (LLM) or generative pre-trained transformer (GPT).

Example 66 includes the field device of any of examples 46-65, wherein the interactive display device is a touch screen.

Example 67 includes the field device of any of examples 46-65, wherein the field device is ruggedized.

Example 68 includes the field device of any of examples 46-65, wherein the field device is configured for offline use.

Example 69 includes the field device of any of examples 46-65, wherein the field device is a laptop computer.

Example 70 includes the field device of any of examples 46-65, wherein the field device is a notebook computer.

Example 71 includes the field device of any of examples 46-65, wherein the field device is a netbook.

Example 72 includes the field device of any of examples 46-65, wherein the field device is a tablet computer.

Example 73 includes the field device of any of examples 46-65, wherein the field device is a convertible tablet computer.

Example 74 includes the field device of any of examples 46-65, wherein the field device is a smartphone.

Example 75 includes the field device of any of examples 46-65, wherein the field device is an Android phone.

Example 76 includes the field device of any of examples 46-65, wherein the field device is an iPhone.

Example 77 includes the field device of any of examples 46-65, wherein the field device is a Windows phone.

Example 78 includes the field device of any of examples 46-65, wherein the field device comprises a server.

Example 79 includes the field device of example 78, further comprising a guest infrastructure to realize server functions.

Example 80 includes the field device of example 79, wherein the guest infrastructure comprises virtualization.

Example 81 includes the field device of example 79, wherein the guest infrastructure comprises containerization.

### DETAILED DESCRIPTION OF THE DRAWINGS

A system and method for providing an AI assistant for investigative questioning will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

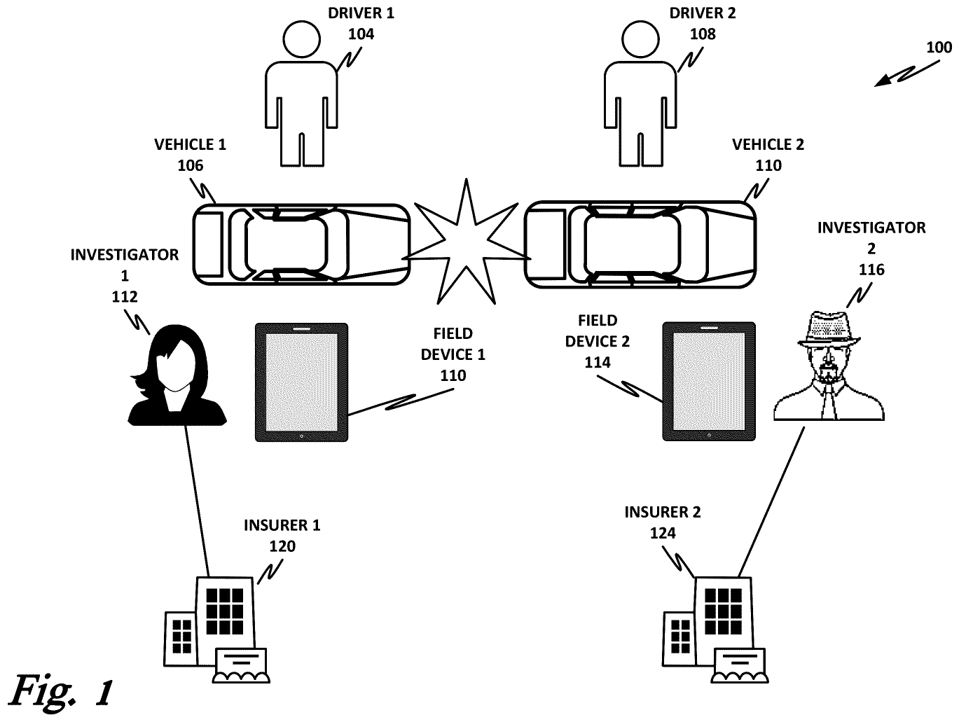

FIG. 1 is a block diagram illustration of an investigation ecosystem 100. Investigation ecosystem 100 is illustrated as an insurance investigation for a collision. However, investigation ecosystem 100 may also be used in other contexts, such as police investigations, detective work, intelligence gathering, interrogation, depositions, or evidence synthesis by a law firm, as illustrative and nonlimiting examples.

In this example that involves a vehicle collision, driver 1 104 operates vehicle 1 106. Driver 2 108 operates vehicle 2 110. Vehicle 1 106 and vehicle 2 110 have been involved in a collision of some kind.

In this example, driver 1 100 is insured by insurer 1 120. Driver 2 108 is insured by insurer 2 124.

Insurer 1 120 dispatches investigator 1 112 operating field device 1 110 to interview driver 1 104. Investigator 1 112 may also interview driver 2 108 (e.g., the claimant) if she is able. In some cases, driver 2 108 may be less willing to speak to investigator 1 112.

Similarly, insurer 2 124 dispatches investigator 2 116 operating field device 2 114 to interview driver 2 108. Investigator 2 116 may also want to interview driver 1 104 if he is able. However, driver 1 104 may feel that he is better represented by investigator 1 112 operating field device 1 110.

Modern insurance investigators 112, 116 often operate field devices 110, 114 as part of their routine investigative services. However, if one of the investigators 112, 116 is operating a field device with greater capabilities, that may give a competitive edge to his or her respective insurer 120, 124. Thus, in this example, insurer 1 120 may provide investigator 1 112 with filled device 1 110, including an AI assistant to help her conduct a better interview with the respective drivers 104, 108. This may enable insurer 1 120 to more correctly determine the respective faults and liabilities between driver 1 104 and driver 2 108.

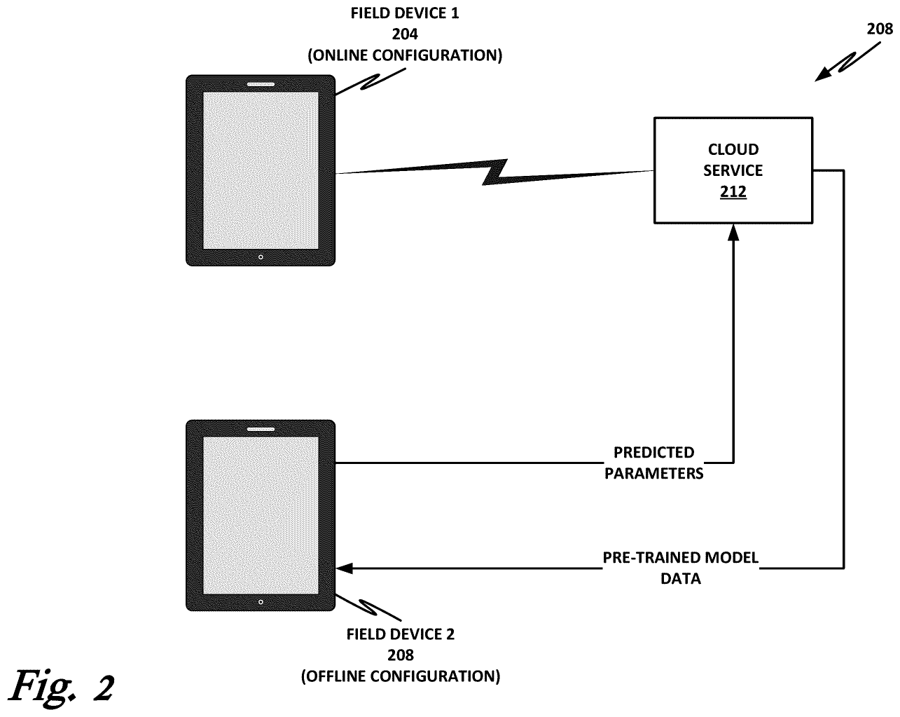

FIG. 2 is a block diagram illustration of a device ecosystem 200. FIG. 2 illustrates that an insurer such as insurer 1 120 (FIG. 1) may operate a cloud service 212. Cloud service 212 may be beneficial in that a cloud-based system may have more available resources, and more flexibility in allocating or deallocating resources as necessary. In contrast, field devices 204, 208 may have more limited memory and processing power, and thus may be less capable of providing a fully realized AI assistant. Thus, field device 1 204 may be operated in an online configuration, in which field device 1 204 can communicate with cloud service 212 in real time during the investigation. Field device 1 204 may offload many functions to cloud service 212, such as digital eye services, voice recognition, text-to-speech conversion, mood and sentiment determination, and provisioning of question prompts. However, not all services necessarily need to be hosted on cloud service 212. For example, there may be advantages in speed by hosting services locally, such as by performing text-to-speech or other services locally. Field device 1 204 may also include backup models (e.g., a scaled-down LLM or other AI services) that can provide a degree of aid even if connectivity to cloud service 212 is lost.

In contrast, field device 2 208 is in an offline configuration. Field device 2 208 is designed specifically to operate offline, such as in cases or situations where the investigator is expected to have less connectivity. In some embodiments, field device 2 208 may be provisioned with a better processor and more memory than field device 1 204. This may enable field device 2 208 to more usefully run a limited single-purpose or bespoke GAI for prompting the field investigator. Furthermore, field device 2 208 may be ruggedized, such as with waterproofing, shock protection, and protection against other elements. Many sites or circumstances with limited connectivity also experience harsher environmental or weather conditions. For example, if an insurance investigator is investigating homesites in the immediate aftermath of a hurricane, not only may wireless and other network communications be disrupted, but the investigator may be expected to encounter mud, muck, dangerous chemicals, and other harsh conditions. Similarly, remote locations with limited connectivity may be remote for a reason. Such locations may experience temperature extremes (as in deserts and/or tundra), mountain peaks, offshore platforms (with extreme winds and salinity), oceangoing vessels, or other remote locations. Such conditions and locations may call for a ruggedized device.

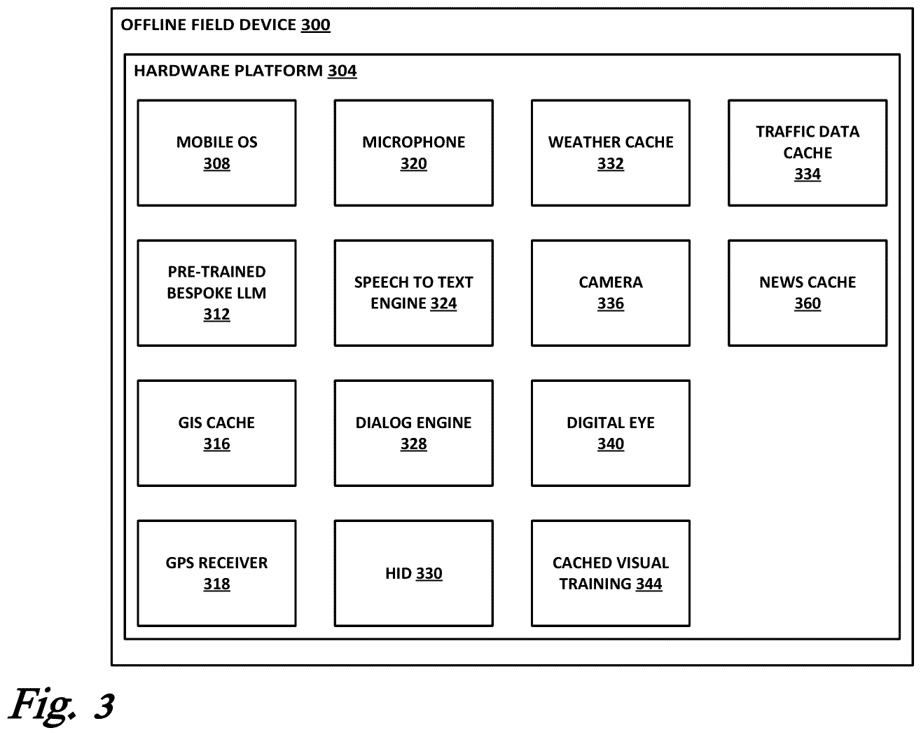

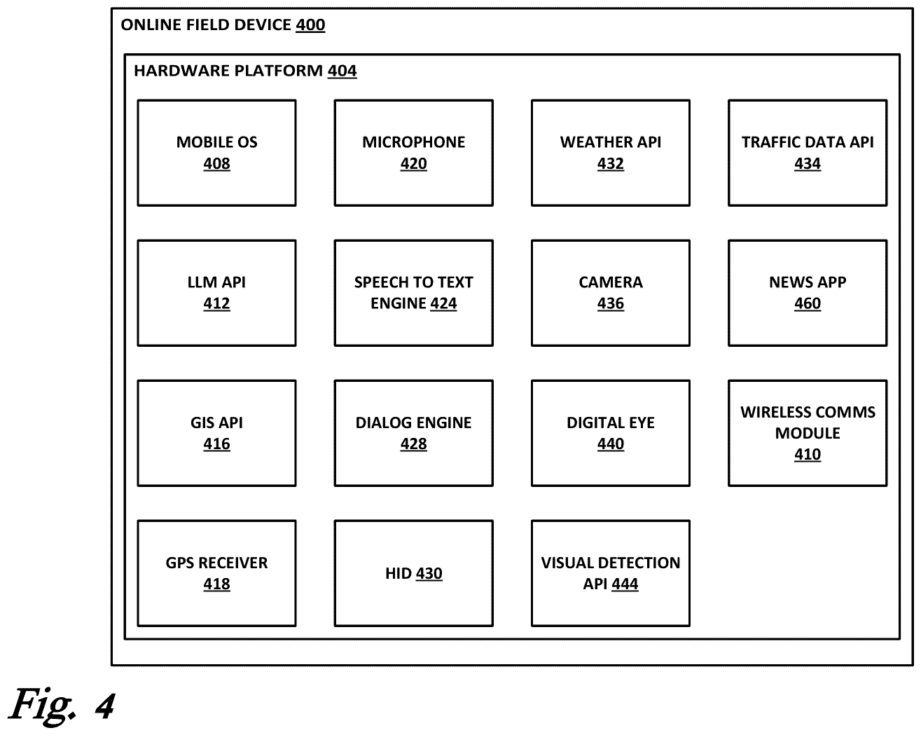

FIG. 3 is a block diagram of an offline field device 300. Offline field device 300 is hosted on a hardware platform 304, which as described above may be a ruggedized hardware platform, and which may be provisioned with more processor and memory capacity than an online field device such as online field device 400 (FIG. 4).

In an illustrative embodiment, offline field device 300 includes a mobile operating system 308. This may be, for example, Android OS, Apple IOS, Microsoft Windows Mobile (or equivalent), mobile Linux, mobile UNIX, ChromeOS, or other similar mobile operating systems. In other embodiments, offline field device 300 may also be provisioned with a nonmobile OS such as Microsoft Windows, Apple macOS, Linux, UNIX, or other operating system.

In this example, offline field device 300 includes a pre-trained bespoke LLM 312. This may be a GAI that has been pre-trained to provide a specific function, such as question prompting. Because offline field device 300 may have more limited compute resources compared to a larger system in a cloud-based system, pre-trained bespoke LLM 312 may not have the full capacities of a general-purpose LLM. Rather, it may be limited to a specific purpose such as guiding a conversation for an insurance investigation or other investigation.

Offline field device 300 also includes a GIS cache 316. This may provide a cache of downloaded maps and other GIS data that may be specific to the expected situs of the investigation. For example, if the investigator knows that she will be investigating a traffic accident at a particular rural intersection, she may download local maps and other GIS data around that intersection, such as within 100 m, 500 m, 1 km, 1 mile, 2 miles, 5 miles, or 10 miles by way of illustrative and nonlimiting example.

Off-line field device 300 may also include a GPS receiver 318. Advantageously, even in places where internet connectivity is not present or unreliable, a GPS receiver 318 may still be able to receive GPS location data from a geosynchronous GPS satellite. Thus, GPS receiver 318 may be useful even in remote locations and can be used to correlate to GIS cache 316 to show real-time updates of a location.

A microphone 320 may be positioned to record conversations between the insurance investigator and the party being interviewed.

Speech-to-text (STT) engine 324 may be a locally-operated STT engine, and may transcribe the conversation. In an illustrative example, STT engine 324 has been pre-trained with samples of the investigator's voice, so that it can discriminate between the investigator and the party being interviewed. STT engine 324 may also be generally able to differentiate between different voices, and thus mark unknown parties with generic labels such as “Party 1,” “Party 2,” “Party 3,” and similar. STT engine 324 may also parse the text into discrete utterances, which can aid LLM 312 in understanding the flow of the conversation.

A dialogue engine 328 may format the raw utterances from STT engine 324 into a formatted dialogue or conversation. Furthermore, dialogue engine 328 and/or STT engine 324 may include an AI trained to recognize tonal shifts or sentiments from a user's spoken words or voice. For example, voice inflections can be used to identify mood changes such as ingenuousness, deceit, stress, strain, hostility, nervousness, or other indicia of mood. Thus, dialogue engine 328 may also mark up the dialogue with hints that indicate the detected mood or sentiment of the user speaking. This marked up conversation can be provided to LLM 312 so that LLM 312 can act on the content and sentiments. In an example, dialogue engine 328 may format additional data (i.e., information inferred but not spoken by either party) with an appropriate delimiter such as square brackets ([ ]).

A human interface device (HID) 330 may include input and output devices or combined input/output devices, such as a keyboard, screen, trackpad, mouse, touchscreen, speech synthesizer, voice prompt, or other interface devices.

Weather cache 332 may include a cache of reported weather conditions relevant to the location, including present weather conditions and weather conditions at the time of the incident. For example, present weather conditions may be used to provide additional safety for the investigator, by ensuring that she does not enter dangerous conditions. This may be particularly important when investigating dangerous circumstances such as adverse weather events like tornadoes, hurricanes, earthquakes, or similar. Weather information can help to keep the investigator safe, even when adverse conditions are present.

A camera 336 may be used to take photographs of objects relevant to the investigation. For example, an investigator investigating a car accident may take photographs of the damaged vehicles, and a digital eye 340 may examine the photographs and may summarize what the photographs appear to indicate. For example, if a party claims to have been tee-boned in the accident, but the photographic evidence is more consistent with a sideswipe, then LLM 312 may prompt the investigator to ask specific questions about the legitimacy of the alleged tee-bone event.

Digital eye 340 may rely on cached visual training data 344, which may include pre-trained information, based on images of many different types of accidents. This may aid digital eye 340 in determining what is shown in various photographs.

Traffic data cache 334 may include a cache of reported traffic conditions at the time of the accident. Because traffic conditions can legally change what constitutes “ordinary caution” or “negligence” in a given circumstance, traffic data cache 334 may provide LLM 312 with useful context for asking questions to establish liability.

A news digest 360 may include an AI-generated summary of current events that may affect the investigation. For example, if the incident was associated with a riot or “mostly-peaceful protest,” LLM 312 may use the news digest 360 to ask relevant questions, such as what brought the party to the event, what role, if any, the party played in the event, and other information relevant to liability. Furthermore, news cache 360 may include planned future activity, which may be correlated with GIS cache 316, to help the investigator avoid dangerous situations if unrest is ongoing.

FIG. 4 is a block diagram of an online field device 400. Online field device 400 is based on a hardware platform 404. Because online field device 400 is expected to operate in different conditions compared to offline field device 300 (FIG. 3), hardware platform 404 in some cases need not have as much computer capacity as hardware platform 304 (FIG. 3). Furthermore, in cases where online field device 400 is expected to operate in non-adverse environmental conditions, hardware platform 404 may not need to be ruggedized, or may not need to be as rugged as device 300 (FIG. 3).

Online field device 400 includes a mobile OS 408, which may be analogous to mobile OS 308 (FIG. 3).

LLM API 412 may be functionally analogous to pre-trained bespoke LLM 312 (FIG. 3). However, because online field device 400 is expected to have reliable network connectivity, the LLM need not be fully hosted on online field device 400. Some lesser or cached functions may be locally hosted, but LLM API 412 may primarily access GAI functionality via an application programming interface (API).

GIS API 416 may be functionally analogous to GIS cache 316 (FIG. 3), but may or may not include cached local data. In some cases, it may still be valuable to cash local data for speed of access and in case of loss of connectivity. But because GIS API accesses online JS services via an API, the cash may be smaller.

GPS receiver 418 may be functionally analogous to GPS receiver 318 (FIG. 3).

Microphone 420 may be functionally analogous to microphone 320 (FIG. 3).

STT engine 424 and dialogue engine 428 may be functionally analogous to STT engine 324 (FIG. 3) and dialogue engine 328 (FIG. 3) respectively. However, STT engine 424 and dialogue engine 428 may also include APIs to access more capable engines via a cloud connection, as appropriate to a specific embodiment.

HID 430 may be functionally analogous to HID 330 (FIG. 3).

Weather API 432 may be functionally analogous to weather cache 332 (FIG. 3). However, weather API 432 may not need as much cached data because it may access online weather services via its network connection.

Camera 436 may be functionally analogous to camera 336 (FIG. 3.).

Digital eye 440 may be functionally analogous to digital eye 340 (FIG.
3), and may use visual detection API 444, which may be functionally analogous to cached visual data 344 (FIG. 3). However, visual detection API 444 may not require as much cached data because it may access remote visual detection training data via an API.

Traffic data API 434 may be functionally analogous to cached traffic data 334 (FIG. 3), but may not need as large a cache because it can access online traffic data via an API.

News API 460 may be functionally analogous to news cache 360 (FIG. 3). However, news API 460 may not require as large a cache as it may have access to online news data via its API.

Wireless communications module 410 may provide wireless communication between online field device 400 and a cloud service such as cloud service 212 (FIG. 2). Wireless comms module 410 may include appropriate wireless technologies such as Bluetooth, Bluetooth low energy (BTLE), Wi-Fi, cellular (3G, 4G, 5G, 6G, or later), satellite communication (e.g., StarLink), or others.

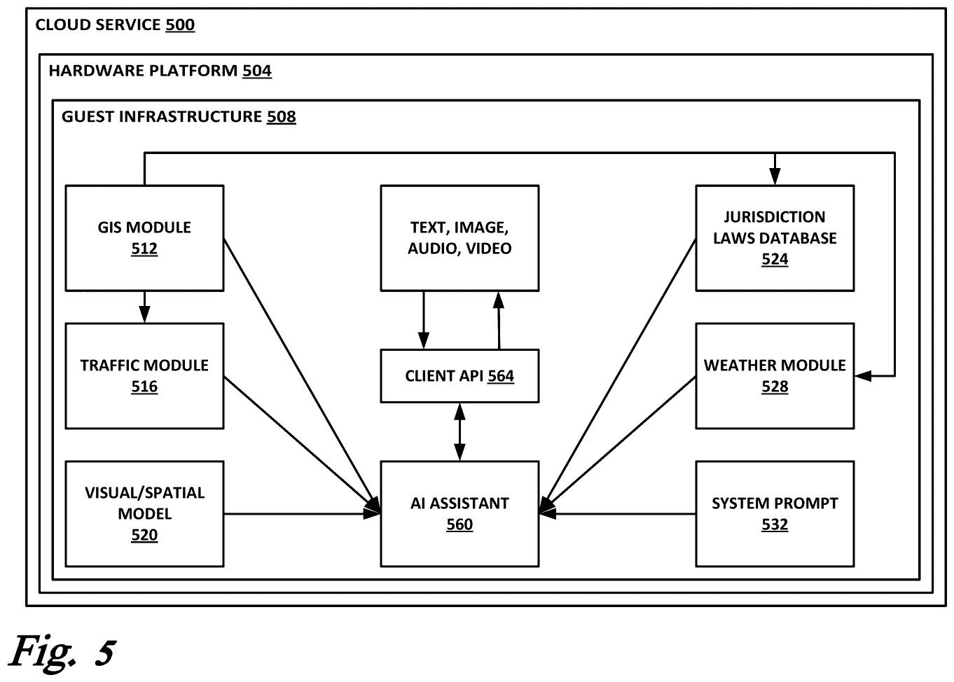

FIG. 5 is a block diagram of selected elements of a cloud service 500. Cloud service 500 is hosted on a hardware platform 504, which may include one or more disparate hardware platforms. Furthermore, hardware platform 504 could include disaggregated hardware in a data center, or across multiple data centers.

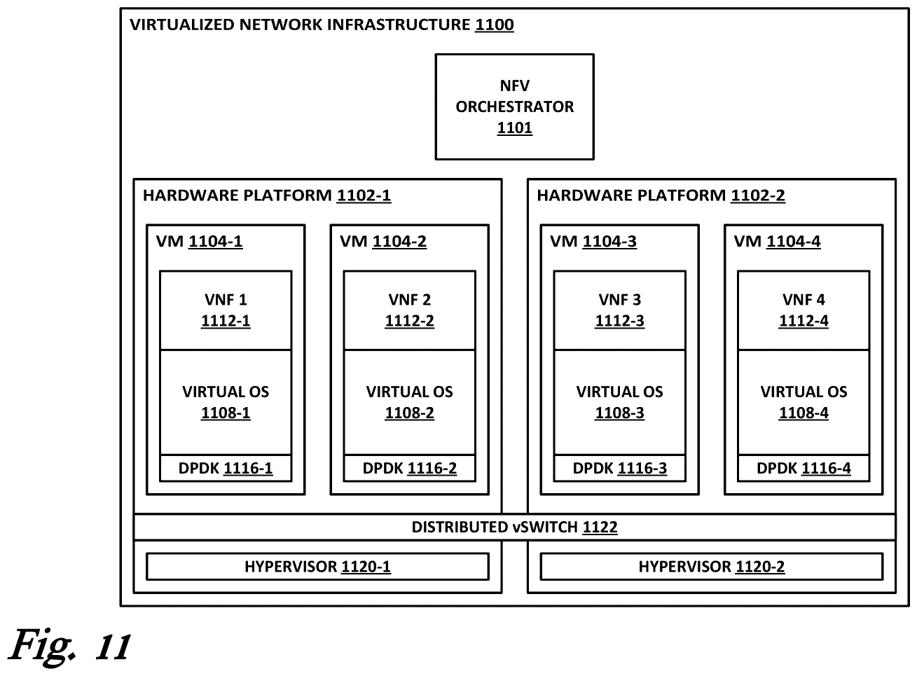

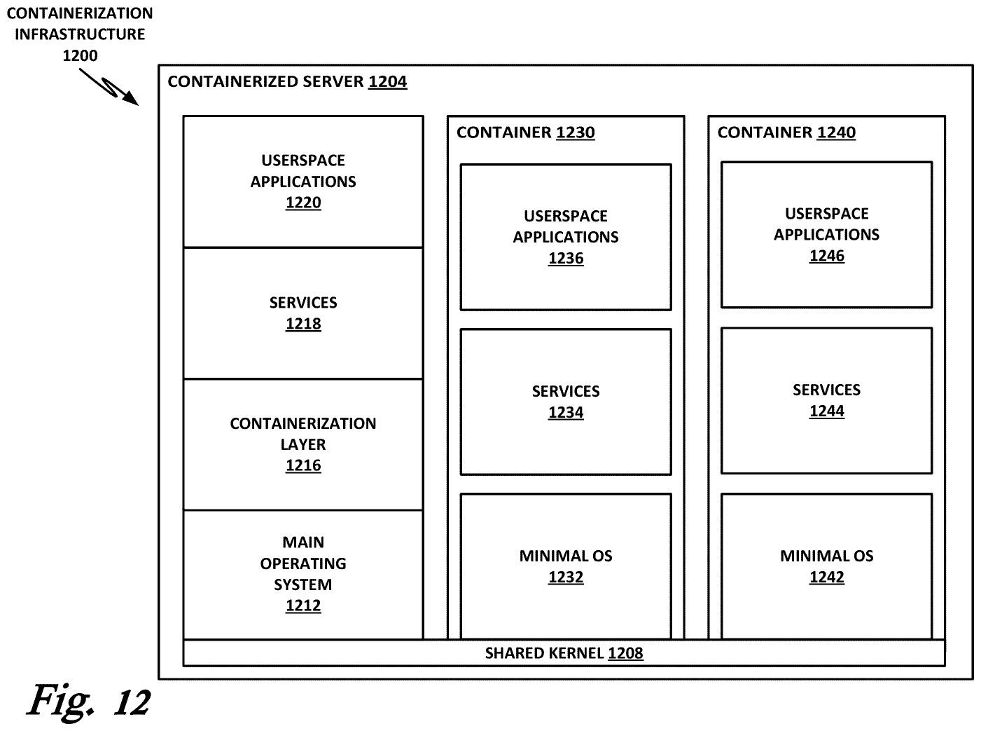

Hardware platform 504 includes a guest infrastructure 508, such as a containerization infrastructure (e.g. as illustrated in FIG. 12, or a virtualization infrastructure as illustrated in FIG. 11. Guest infrastructure 508 could also include other guest infrastructures such as microservices, Snaps, FlatPaks, AppImages, sandboxed applications, or similar segregation technology. Furthermore, in lieu of guest infrastructure 508, some logical functions may be provided as hardware appliances. Throughout FIG. 5, several logical modules are disclosed, and it should be understood that these modules represent a logical division of functionality, and do not necessarily represent a specific hardware or software configuration. In particular, multiple functions could be provided on a single virtual machine, container, microservice, package, or other hardware or software infrastructure. Furthermore, a module illustrated here as a single block could span a plurality of guest devices, services, and/or software modules. Furthermore, some of the modules illustrated here provide duplicate functionality to modules illustrated in FIGS. 3 and 4. This illustrates that some functions may be hosted locally, in the cloud, or in a hybrid configuration.

Cloud service 500 provides an AI assistant 560 configured to aid an investigator in investigating an incident such as an insurance incident. A client API 564 communicatively couples AI assistant 560 to a remote device such as an online or offline field device. Via client API 564, the field device may communicate text, images, audio, video, and other data to and from AI assistant 560.

A purpose of AI assistant 560 is to assist the investigator in performing a guided interview with probative, open-ended, valuable questions. AI assistant 560 may have access to other associated services to enhance its guided conversation.

For example, a system prompt 532 may be used to initially train AI system 560 to create a pre-trained special-purpose LLM or GAI. Once the LLM has been trained, it may be provided as a reduced-scope, special-purpose model that can effectively run on reduced hardware, such as the hardware available on a field device.

A GIS module 512 may provide geolocation data to AI assistant 560, and may also be used to select appropriate laws from a jurisdiction laws database 524. This provides AI assistant with geospatial information about the location, as well as appropriate laws for the situs of the incident.

Traffic module 516 may provide cached and/or real-time traffic data to AI assistant 500, which may enable AI system 560 to integrate traffic information into its conversational reasoning.

Weather module 528 may provide real-time and/or cached weather data, which can affect visibility, road conditions, and other investigation concerns.

A visual and spatial model 520 may provide visual-spatial data that AI system 560 can use to enhance its suggested dialogue. For example, AI assistant 560 may compute appropriate stopping distances between two vehicles based on the jurisdictional laws from database 524, GIS data from module 512, weather module 528, and/or traffic data from module 516. All of these may affect what constitutes a safe stopping distance in a given circumstance.

Based on its available data sources, AI assistant 560 determines which data are needed for an investigation to guide a conversation. The assistant may also determine how to elicit the necessary data via probative, open-ended, and in appropriate circumstances, non-confrontational questions. For example, rather than asking, “Did you keep a safe following distance behind the other car” (the answer will almost always be “Yes”), the AI assistant may prompt the investigator to ask, “Go back 10 seconds before the accident. Where were you?” Follow-up questions may then be asked to refine the answer and to guide the conversation into collecting the necessary information to determine liability in the situation.

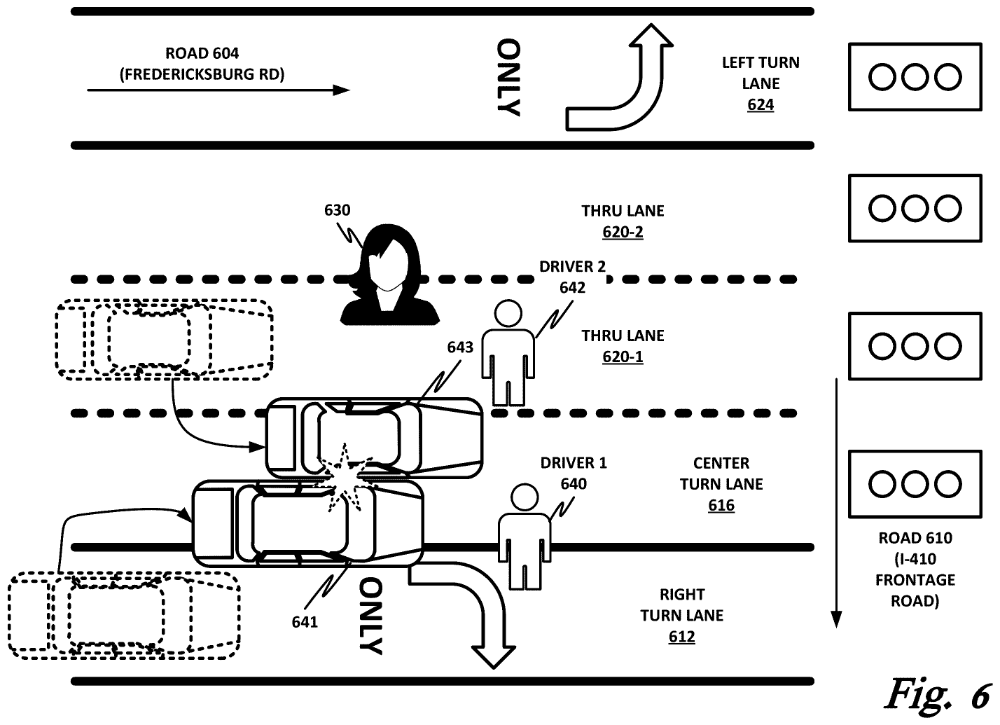

FIG. 6 is a block diagram of a traffic structure and an accident to illustrate the operative principles of the present specification. The traffic structure of FIG. 6 is based on a real intersection in San Antonio, Texas, to provide a concrete illustration. However, the incident presented is not based on any specific incident or case. Rather, this is a hypothetical incident that represents a common type of traffic accident.

This traffic structure is based on the southbound lanes of Fredericksburg Road (callout 604) as it crosses the westbound frontage road for Northwest Loop 410/Connally Loop (callout 610). As illustrated, the intersection is controlled by traffic lights. As of this writing, the speed limit on the southbound lanes of Fredericksburg Road is believed to be 40 MPH.

The road structure includes a right turn lane 612. This is a turn-only lane, so vehicles in this lane must turn right onto the frontage road. Right turn lane 612 is demarcated by a solid white line.

Center turn lane 616 continues across the westbound frontage road, onto a freeway overpass, then to another stoplight intersection as it crosses the eastbound frontage road for Northwest Loop 410. After crossing the eastbound access road, Fredericksburg Road continues on toward central San Antonio. Vehicles in center turn lane 616 may turn right or may proceed straight.

Through lanes 620-1 and 620-2 also proceed through the intersection, across the freeway overpass, across the next intersection for the eastbound frontage road, and on towards central San Antonio. Vehicles in through lanes 620 are required to proceed forward through both intersections.

Left turn lane 624 passes through the westbound frontage road, across the freeway, and terminates at the traffic signals for the eastbound frontage road. Vehicles in left turn lane 624 must turn left onto the eastbound frontage road after passing over the freeway overpass.

In this illustrative event, driver 1 680 operates vehicle 1 641, while driver 2 642 operates vehicle 2 643. As illustrated, vehicle 1 641 started in right turn lane 612, and attempted to change lanes into center turn lane 616. Vehicle 2 643 started in through lane 620-1, and attempted to change lanes into center turn lane 616. Because both vehicles entered center turn lane 616 at the same time, they were in a sideswipe collision.

In this example, driver 2 642 is insured by a carrier, which assigns investigator 630 to investigate the accident, usually within about 48 hours of the accident. Investigator 630 may wish to speak to both driver 2 642 and driver 1 640 if possible. She may also want to gather photographs of the accident scene, gather or take photographs of damage to the vehicle, and collect police reports, witness statements, and any other information available to help her understand the mechanics of the accident. Investigator 630 may have a charge to factually and correctly determine which driver or drivers were at fault in the accident, and if there is any shared liability, what percentage of liability is assignable to each driver. This may help investigator 630's insurance company to determine whether it needs to pay a claim or collect the claim from the other driver's insurance company. The investigation may also be essential in the case of litigation between the two drivers and their insurance companies.

The following dialogue represents an illustrative guided interview between investigator 630 (“Investigator”) and driver 2 642, here named Mr. Dan Jones. Driver 1 640 is named Mr. Jeb Smith. Prompts and deductions from the AI assistant (as displayed on a field device operated by investigator 630) are marked as “Assistant,” and in some embodiments, may not show up on a real-time transcript. They are illustrated here to aid in understanding the flow of the conversation. In this transcript, content within curly braces ({ }) represents contextual information not part of the conversation. Information in brackets ([ ]) is inserted by a dialogue engine based on analysis of spoken and unspoken cues.

Assistant: Start by expressing condolences for the accident and making sure that the driver is OK. Remember that this is a human you are talking to. You will get best results by behaving like a human.

Investigator: Mr. Jones, I'm sorry to hear about your accident. I hope that you are OK. Jones: Yes, I think I'm fine. It was startling, but I don't think I'm hurt.

Assistant: {Stores that Mr. Jones does not express any immediate injuries.} His daughter was also in the car. How is she?

Investigator: I understand your young daughter was also in the car with you. How is she doing?

Jones: It was upsetting for her. She's only four, and it scared her real bad. She cried a lot after, but she's settling down now.

Assistant: {Notes that the passenger does not appear to be injured.} What was the date of the accident?

Investigator: That's good to hear. Now I'd like to get into the details of the accident. And I apologize in advance because I know you already gave us some of this information when you called the first time. I just need to make sure we got everything down right. So, let's start with what date did this happen? Jones: Yesterday.

Investigator: So that would be yesterday, Tuesday, August 20?

Jones: Yes, that's right. [Indicia: Relaxed, cordial]

Assistant: Where were you coming from?

Investigator: When this happened yesterday, where were you coming from? Jones: I was coming from work. Well, actually, there's an in-home day care where we drop our daughter, so I had just picked her up. But she's right near my office. Assistant: Where were you heading? {This is an open-ended question and better than, for example, “Were you heading home?”}

Investigator: And where were you heading? Jones: I was on my way home.

Assistant: What time was the accident?

Investigator: So, you were heading home after work when the accident occurred. What time was it? Jones: Just before 6, I think.

Assistant: Where did the accident occur? Investigator: OK. And where did the accident happen? Jones: It was on Fredericksburg Road, right before the 410 overpass.

Assistant: {Checks GIS data. Infers that direction is still needed.} Which direction were you traveling?

Investigator: Which direction were you headed on Fredericksburg Road?

Jones: Um, south, I guess? [Indicia: Uncertainty]

Assistant: {Checks GIS data for a reference point.} The witness seems unsure. Were you coming from Callaghan Rd? {This is a closed-ended question, but in this case is appropriate and efficient because there are only two possible answers.}

Investigator: So, you were heading towards the 410 frontage road, coming from the direction of Callaghan Road?

Jones: Yes, that's right. I normally turn right on Callaghan to head home.

Assistant: {Notes that this is a deviation from his ordinary route.} Why were you taking a different route?

Investigator: Why did you decide not to turn on Callaghan yesterday?

Jones: So, as I said, I had just picked my daughter up from daycare, and I was going to head over to the Original Donut Shop to get some tacos for dinner.

Assistant: When did he decide to change lanes?

Investigator: So, we have you headed south on Fredericksburg Rd. at about 6 μm to get tacos. When did you decide to change lanes?

Jones: Well, I noticed that the traffic on Fredericksburg past 410 was really heavy. So, I thought, maybe I'll just go ahead and hit that Popeye's over at Callaghan and 410, because it's on the way home. So, I went to change lanes so I could get on the access road, and then out of nowhere, this Lexus slammed into the side of me. [Indicia: Agitation]

Assistant: {Needs to establish familiarity.} How often do you travel down Fredericksburg instead of turning on Callaghan?

Investigator: You said that you usually turn on Callaghan, but yesterday you decided to get tacos, so you went down Fredericksburg instead.

Jones: That's right. Why, is that a problem? [Indicia: Nervous, reticent]

Assistant: {Does not want the interview to become confrontational, but still needs to establish familiarity. Notes that the Investigator asked a different question from the prompt, and the information is still needed} Reassure the witness that there is no problem. How often do you travel down Fredericksburg instead of turning on Callaghan? Investigator: No, not a problem at all. I just want to make sure I'm clear on the details. How often do you go home that way?

Jones: We like to get takeout for dinner once a week or so, and we really like the tacos at Original Donut Shop, so pretty frequently.

Assistant: {Driver is familiar with the route. Checks lane structure for the Fredericksburg/410 Overpass intersection. Brings up a map. “Display Visual Aids” button lights up to suggest use of visual aids.} Which lane were you in to start with?

Investigator: {Displays visual aids and shows Mr. Jones the map.} Can you show me which lane you were in?

Jones: {Uses stylus to mark that he was originally in the right through lane.} I was in this lane to start with. {Uses stylus to draw an arrow into the center turn lane.} Then I moved over into this lane so I could turn right onto the access road.

Assistant: {Jones was changing lanes from left to right, therefore had the right of way per Texas Transportation Code. Now needs to establish weather.} What were the weather conditions?

Investigator: What was the weather like that day? Jones: Typical San Antonio day in August. Hot, bright, sunny, clear skies.

Assistant: {Establishing traffic.} What was the traffic like?

Investigator: And what was the traffic like?

Jones: Well, it was moving along pretty good on my side of 410. Better than normal, I'd say, for that time of day. But like I said, I could already see a bunch of cars piled up at the light on the overpass, and I didn't want to get stuck in that.

Assistant: {Needs to establish that driver exercised ordinary caution.} When did you first see the Lexus?

Investigator: Now, let's go back to the accident itself. When did you first see the Lexus? Jones: I checked the lane before I merged over, and I kind of vaguely remember that I may have seen him then. But I'm certain he was in the other lane. The far-right, the turn-only lane. [Indicia: Defensive.]

Assistant: When did you first see the Lexus in the lane you were changing to?

Investigator: When did you first notice that the Lexus was in the lane you were changing into?

Jones: I didn't see him at all until he slammed into the side of me. [Indicia: Agitation] Assistant: {Still probing ordinary caution, and probing the story of not seeing the Lexus.} How fast were you traveling before the collision?

Investigator: What was your speed immediately before the collision?

Jones: Well, I was going about 40 down Fredericksburg, and the light was green, but I was slowing down because I could already see the cars stopped on the overpass. That's why I decided to go the other way.

Assistant: {According to his testimony, Mr. Jones was not speeding, as the speed limit on that portion of Fredericksburg Rd. is 40, per GIS data. Determines that because Mr.

Jones was moving from the left lane to the right lane, he had the right of way. The other driver, Mr. Smith, is likely at fault. Mr. Smith also appears to have crossed the solid white line out of the turn-only lane. However, Mr. Jones may have contributory negligence if he did not signal, and he may have been too close to the intersection. Need to elicit turn signal usage} Where were you on the road when you decided to move to the right lane? Investigator: Can you please show me on the map about where you were when you decided to go home the other way?

Jones: {Marks a spot on the map with the pen.} I guess I was about here when I noticed there was heavy traffic further down Fredericksburg. So, I checked to the right, flipped on my turn signal, and changed lanes.

Assistant: {Notes that Jones now claims to have checked his blind spot and claims to have used turn signal, decreasing his potential negligence.} Please mark where the accident happened.

Investigator: Will you please mark here, on the tablet, to the best of your ability, where the accident happened?

Jones: {Marks a spot about 50 feet ahead of the intersection.} About here, I think.

Assistant: Move the car icon from its starting location to the impact point.

Investigator: OK, this red icon represents your car. Can you please place it approximately where you were when you decided to change lanes?

Jones: Sure. {Uses stylus to move car icon to a point.} I guess I was about here when I decided to change lanes.

Assistant: Move the car icon to the collision.

Investigator: Now please move the car icon to show how the collision happened.

Jones: So I was just in this lane here, and then I was slowing down when I saw the traffic, and I moved over into the lane here. {Moves car icon with stylus}

Assistant: Show where the other car was when you first saw it.

Investigator: Now, this blue car icon represents the Lexus. Can you show me where it was when you first saw it?

Jones: Yeah, like I said, I'm not positive, but I'm pretty sure I saw it in this right turn-only lane here behind several other cars. {Places blue icon in the right turn lane, about four car lengths back.} Then, next time I saw him was when he was slamming into the side of me. {Uses stylus to move blue car icon into the center turn lane.}

Assistant: {Determines that at 40 mph, even while slowing, Mr. Jones was too close to the intersection to have given sufficient signaling time. Assigns a preliminary fault of 5% for unsafely changing lanes too close to the intersection and 10% for failing to give sufficient signaling time. Displays comparative negligence on GUI, with backing statutes and evidence.} What happened immediately after the accident? {This may elicit excited utterances from either party.}

Investigator: Now let's go the moments immediately after the accident. What happened next.

Jones: That {censored}-Smith, was his name? He hopped out of his car like he's the {censored} king of the world, and came over and started screaming through my window. Like yelling, “What's the matter with you? You {censored} came out of nowhere and rammed into me? This is an expensive car! You're going to pay for this, you {censored}!”

I didn't even have time for him. Like I said, my daughter was really freaked out, she was crying and wailing, so I just told him to back the {censored} off. [Indicia: Extreme Agitation} Assistant: {Notes that Mr. Smith's post-accident statements may be admissible as excited utterances and as admissions of a party opponent, in the case of mediation, arbitration, or litigation. The windows being rolled up may affect sound resolution.} How well could you hear him?

Investigator: How clearly could you hear him?

Jones: Oh, I could hear him, all right. He was . . . really, really loud.

Assistant: {The statements are persuasive that Mr. Smith did not see Mr. Jones before he changed lanes, which influences negligence because Jones had the right of way. Jones still has not yet mentioned whether police were called, so a direct, closed-ended question may be necessary here.} Were the police called?

Investigator: Did anybody notify the police?

Jones: Yeah. Smith called-again, really worked up, shouting and cussing, saying I rammed into him, and he was meeting important people. Stuff like that. A cop came out and spoke to both of us and took our statements. [Indicia: Agitation decreased]

Assistant: What was the officer's name?

Investigator: Do you recall the officer's name?

Jones: Yeah, he gave me a card. [Pause.] Looks like it was Officer Jesse Sanchez.

Assistant: What is the officer's badge number?

Investigator: Did you get Officer Sanchez's badge number?

Jones: Yeah, it's here on the card. Badge No. 3147.

Assistant: What did Officer Sanchez do at the scene?

Investigator: Thank you. What did Officer Sanchez do?

Jones: He talked to both of us and wrote down some notes. He didn't seem any more impressed with Smith than I was.

Assistant: Do you have a copy of his report?

Investigator: Did Officer Sanchez give you a copy of his report? Jones: No, I don't think so.

Assistant: We can get a copy.

Investigator: That's ok. We can get a copy direct from SAPD.

Assistant: Was either driver ticketed? Investigator: Did Officer Sanchez write either of you a ticket?

Jones: He wrote the other guy a ticket because his car registration expired at the end of last month. But he said he′d leave it to the insurance companies to hash out who's at fault. I don't think he wanted to get into it with that {censored} Smith.

Assistant: {Notes that Mr. Smith got a ticket, but it was unrelated to liability in the accident.} Did you or the other driver take any pictures at the scene?

Investigator: Did you or the other driver take any pictures at the accident scene?

Jones: I don't think so. I know I didn't. I think the cop might have.

Assistant: Check police report, in case Officer Sanchez took any pictures. {However, police usually do not take pictures of minor accidents.} Did either driver have dashcam footage?

Investigator: Ok, we can get those pictures from the police report. What about dashcams? Do you or the other driver have dashcams?

Jones: I don't have a dashcam. Not sure about the other guy.

Assistant: {Notes that there may be dashcam footage available from the other driver. This should be procured if it exists.} How did you get home after the accident? {If the car was drivable, the collision was likely lower-speed.}

Investigator: After Officer Sanchez left, how did you and your daughter get home?

Jones: We drove home. The side of the car's a big mess and the alignment feels off, but it drives well enough to get us a couple miles home.

Assistant: Do you need a rental?

Investigator: Sounds like you don't want to take your car too far until you get it fixed. Are you going to need a rental?

Jones: Definitely. My wife has a car, but she works too, so I can't drive that.

Assistant: How did the other driver leave the scene?

Investigator: Did you happen to notice how Mr. Smith left when you were all done?

Jones: I'm pretty sure he drove off in his car too. In fact, now that I think about it, I'm sure he did, because he turned down the access road, and I thought, “Oh great, he's going the same way as me.”

Assistant: Did your vehicle have any prior damage?

Investigator: Now, just so we know what we're covering in connection with this accident, did your vehicle have any existing damage before the accident?

Jones: There's a small ding on the rear passenger's side fender from when my brother whacked a golf ball into it a couple of years ago.

Assistant: Please mark the approximate location. {Lights up “Visual Aids” button to suggest using the visual aids.}

Investigator: Can you mark here on the red car icon approximately where the ding is?

Jones: {Takes stylus and makes a small X.} It's about here.

Investigator: Thank you.

Assistant: Did you notice any damage on the other car?

Investigator: Did you happen to notice any pre-existing damage on the other car?

Jones: How would I know that? I barely saw him before the accident. I don't go around cataloging damage of every car on the road. [Indicia: Exhaustion, Agitation.]

Assistant: {Has collected all necessary information, and infers that further questioning will likely provoke hostility.} No more questions.

Investigator: Thank you for your time, Mr. Jones. I think we have what we need for right now. I hope that you and your daughter can start feeling better about all this. Our claims adjuster will get back to you soon.

Jones: So, does that mean that I'm responsible for the accident? [Indicia: Irritability] Assistant: We will cover you now. If Mr. Smith is at fault, you will be reimbursed for your deductible.

Investigator: The way it works is we'll get your claim paid now, minus your deductible, so that you can get your car fixed ASAP. Then, once our investigation is complete, we'll negotiate with Mr. Smith's insurance company. If we determine that he's fully liable, then you'll get 100% of your deductible back.

Jones: OK. I guess that works.

Assistant: You have an option to wait for a liability determination.

Investigator: If you prefer, we can hold off on any payments until the investigation is finished.

Jones: No, this is fine. I'll pay the deductible for now.

If Mr. Smith, the claimant driver, is willing to speak with the investigator, the investigator may also have an AI-guided conversation with him. In this illustrative example, she may determine that he was unfamiliar with the intersection. He was trying to follow GPS directions to “some Indian restaurant” for a friend's birthday dinner, when he realized he was in the turn-only lane. He changed lanes into the center turn lane, when “suddenly, this Honda side-swiped me.” These facts support the conclusion that Mr. Smith is primarily responsible for the accident, as he did not have the right-of-way, and no overriding facts change the analysis. If the case goes into arbitration or litigation, Mr. Smith's unfamiliarity with the area, and the fact that he crossed the solid white line, may also weigh against him.

Furthermore, if Mr. Smith makes a claim for damage on the right side of his vehicle, the carrier may dispute this claim based on testimony and physical evidence (e.g., photographs). Testimony establishes this as a side-swipe case that only affected the left (driver's) side of Mr. Smith's car, and there is no collision damage on Mr. Jones' car that would correspond to right (passenger's) side damage on Mr. Smith's car. There is also no testimony that the collision forced Mr. Smith into a static object (e.g., a light post) or into a different vehicle. Thus, the damage on the right side of the Mr. Smith's car is most likely unrelated to the present accident.

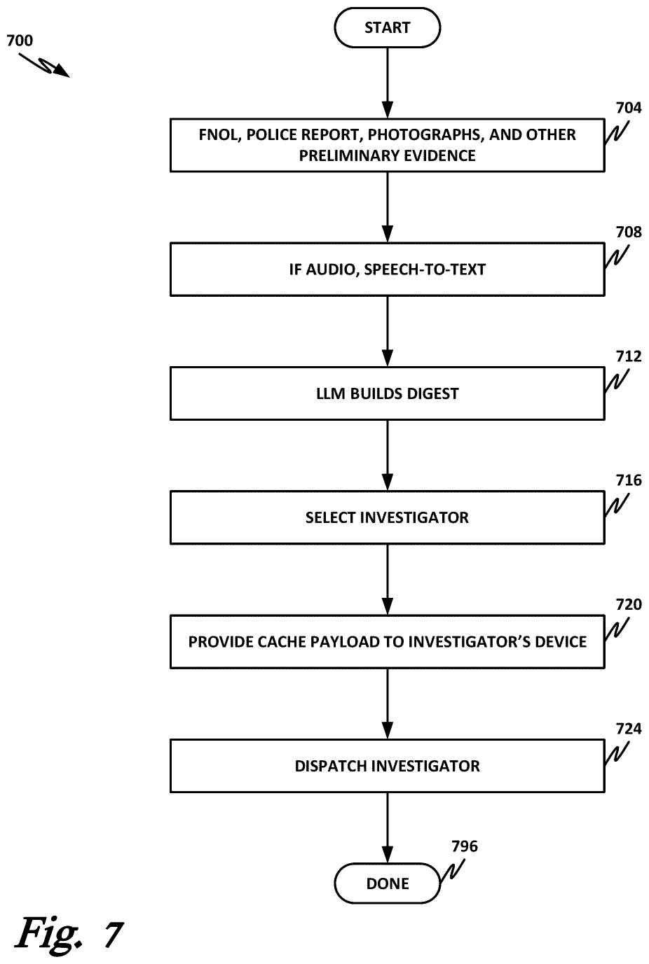

FIG. 7 is a flowchart of a method 700, which method may be used to prepare a field device for an investigation.

In block 704, the carrier receives a first notice of loss (FNOL). In cases where the investigation is not an insurance investigation, then this may be a different form of initial report.

In block 708, if the FNOL or initial report is provided via audio (e.g., via recorded phone call), then the audio transcription may be converted to text via an STT engine.

In block 712, a GAI such as an LLM builds a digest of the FNOL. This may include key details such as the time, place, parties, property damage, and whether any people were hurt.

In block 716, an investigator is selected. In some cases, an AI may match investigators based on capabilities and preferences stored in a database. In other examples, a human may select the appropriate investigator.

In block 720, the system may prepare a cache payload for the investigator's field device. Depending on whether the device will be operating as an online device or offline device, the system may select different quantities or levels of cached data. For an offline device, more cached data may be provided, including additional GIS data, traffic data, weather data, news data, and others. An appropriate pre-trained, reduced-size LLM may also be selected for the offline device. These data may then be transferred to the field device before it goes offline, so that it is ready for operation. In the case of an online field device, less cache data may be transferred to the device.

In block 724, the investigator is assigned to begin the investigation.

In block 796, the method is done.

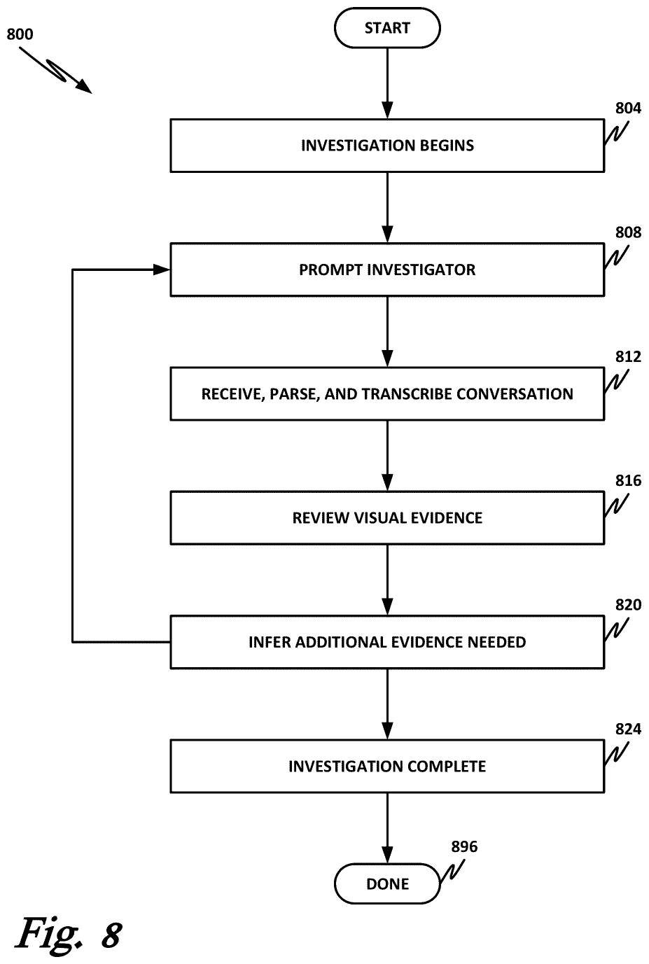

FIG. 8 s a block diagram of a method 800 of performing an investigation.

In block 804, the investigator begins the investigation.

In block 808, based on available data, the LLM may generate a prompt to help the investigator ask a question, such as an open-ended, probative, and/or beneficial question.

In block 812, the investigator asks an appropriate question, and utterances are recorded via a microphone. The dialogue engine may parse the conversation into discrete utterances spoken by each party. As described above, the dialogue engine may recognize the voice of the investigator to segregate questions from responses, and may also be able to recognize that there are multiple voices even if the voices are not known. The STT engine may then transcribe the audio into text, and may provide hints such as sentiment, based on language and tone.

In block 816, the system may also review any new visual evidence provided. A text-to-image AI may summarize the new visual data so that the LLM can act on it in suggesting questions.

In block 820, the GAI infers which additional evidence may be needed for the investigation. It then crafts a recommended query, which may be a simple or straightforward question prompt. The question prompt need not be conversational, as the human element is handled by the human investigator.

As the investigation continues, returning to block 808, the GAI provides the prompt to the investigator.

The investigation continues looping between blocks 808 and 820 until the GAI determines that it has the information relevant and necessary to complete the investigation.

In block 824, the GAI may prompt the investigator that she has collected sufficient information and the investigation may conclude. The investigator may then wrap up the conversation, and terminate the proceedings.

in block 896, the method is done.

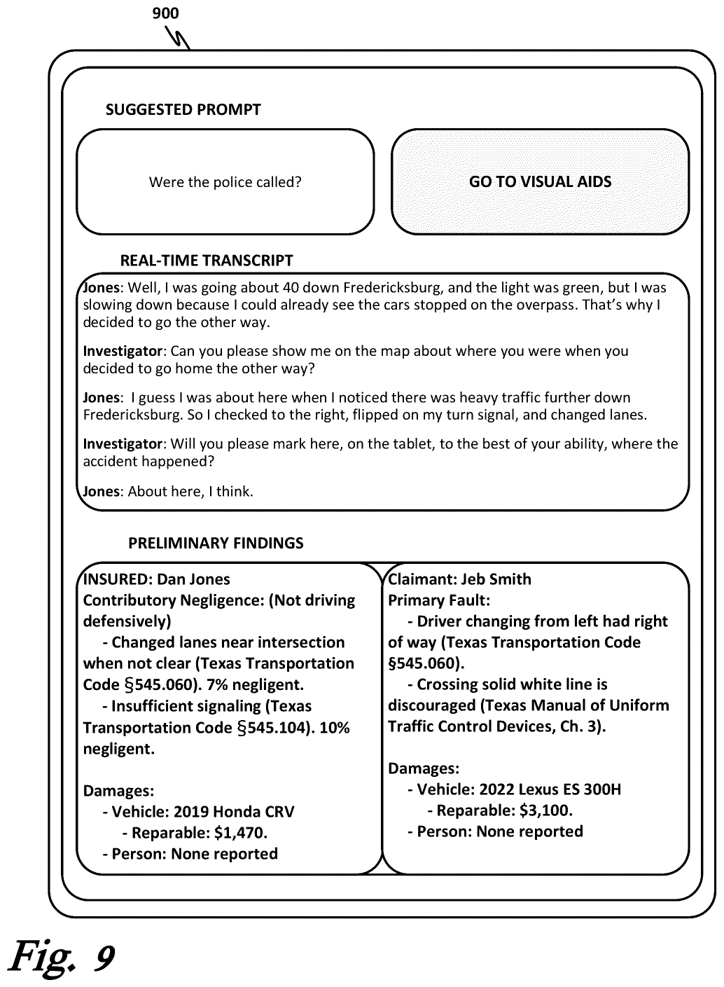

FIG. 9 is a block illustration of an illustrative GUI element that may be displayed on a field device 900. In this illustrative GUI, a prominent and easily-visible element displays the suggested prompt to continue the investigation. In this case, the sample dialogue between the investigator and Mr. Jones from FIG. 6 above is used. The GUI displays information at the point of asking Mr. Jones if the police were called.

The GUI also has a prominent button that the investigator can use to display visual aids, such as photographs, maps (including interactive maps), and other data. A real-time transcript also gives the investigator a reference into the previous state of the conversation.

At the bottom of the GUI, the AI displays its preliminary findings, along with supporting evidence, statutes, and other relevant information.

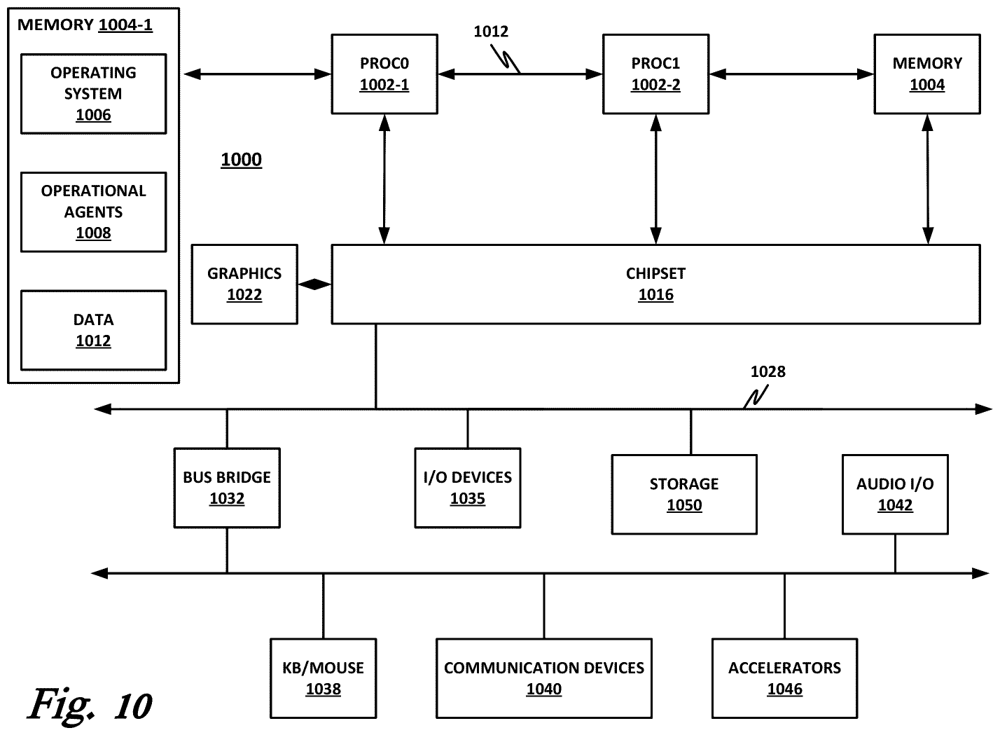

FIG. 10 is a block diagram of a hardware platform 1000. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 1000, even though they may be scattered across a data center, or even located in different data centers.

Hardware platform 1000 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 1000 is arranged in a point-to-point (PtP) configuration. This PtP configuration is popular for personal computer (PC) and server-type devices, although it is not so limited, and any other bus type may be used.

Hardware platform 1000 is an example of a platform that may be used to implement embodiments of the teachings of this specification. For example, instructions could be stored in storage 1050. Instructions could also be transmitted to the hardware platform in an ethereal form, such as via a network interface, or retrieved from another source via any suitable interconnect. Once received (from any source), the instructions may be loaded into memory 1004, and may then be executed by one or more processor 1002 to provide elements such as an operating system 1006, operational agents 1008, or data 1012.

Hardware platform 1000 may include several processors 1002. For simplicity and clarity, only processors PROC0 1002-1 and PROC1 1002-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 1002 may be any type of processor and may communicatively couple to chipset 1016 via, for example, PtP interfaces. Chipset 1016 may also exchange data with other elements, such as a high performance graphics adapter 1022. In alternative embodiments, any or all of the PtP links illustrated in FIG. 10 could be implemented as any type of bus, or other configuration rather than a PtP link. In various embodiments, chipset 1016 may reside on the same die or package as a processor 1002 or on one or more different dies or packages. Each chipset may support any suitable number of processors 1002. A chipset 1016 (which may be a chipset, uncore, Northbridge, Southbridge, or other suitable logic and circuitry) may also include one or more controllers to couple other components to one or more central processor units (CPU).

Two memories, 1004-1 and 1004-2 are shown, connected to PROCo 1002-1 and PROC1 1002-2, respectively. As an example, each processor is shown connected to its memory in a direct memory access (DMA) configuration, though other memory architectures are possible, including ones in which memory 1004 communicates with a processor 1002 via a bus. For example, some memories may be connected via a system bus, or in a data center, memory may be accessible in a remote DMA (RDMA) configuration.

Memory 1004 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 1004 may be used for short, medium, and/or long-term storage. Memory 1004 may store any suitable data or information utilized by platform logic. In some embodiments, memory 1004 may also comprise storage for instructions that may be executed by the cores of processors 1002 or other processing elements (e.g., logic resident on chipsets 1016) to provide functionality.

In certain embodiments, memory 1004 may comprise a relatively low-latency volatile main memory, while storage 1050 may comprise a relatively higher-latency nonvolatile memory. However, memory 1004 and storage 1050 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 1004 and storage 1050, for example, in a single physical memory device, and in other cases, memory 1004 and/or storage 1050 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 1022 may be configured to provide a human-readable visual output, such as a command-line interface (CLI) or graphical desktop such as Microsoft Windows, Apple OSX desktop, or a Unix/Linux X Window System-based desktop. Graphics adapter 1022 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 1022 may include a hardware graphics card, which may have its own memory and its own graphics processing unit (GPU).

Chipset 1016 may be in communication with a bus 1028 via an interface circuit. Bus 1028 may have one or more devices that communicate over it, such as a bus bridge 1032, I/O devices 1035, accelerators 1046, communication devices 1040, and a keyboard and/or mouse 1038, by way of nonlimiting example. In general terms, the elements of hardware platform 1000 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 1040 can broadly include any communication not covered by a network interface and the various I/O devices described herein. This may include, for example, various universal serial bus (USB), FireWire, Lightning, or other serial or parallel devices that provide communications.

I/O Devices 1035 may be configured to interface with any auxiliary device that connects to hardware platform 1000 but that is not necessarily a part of the core architecture of hardware platform 1000. A peripheral may be operable to provide extended functionality to hardware platform 1000, and may or may not be wholly dependent on hardware platform 1000. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 1042 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 1032 may be in communication with other devices such as a keyboard/mouse 1038 (or other input devices such as a touch screen, trackball, etc.), communication devices 1040 (such as modems, network interface devices, peripheral interfaces such as PCI or PCIe, or other types of communication devices that may communicate through a network), audio I/O 1042, a data storage device 1044, and/or accelerators 1046. In alternative embodiments, any portions of the bus architectures could be implemented with one or more PtP links.

Operating system 1006 may be, for example, Microsoft Windows, Linux, UNIX, Mac OS X, IOS, MS-DOS, or an embedded or real-time operating system (including embedded or real-time flavors of the foregoing). In some embodiments, a hardware platform 1000 may function as a host platform for one or more guest systems that invoke application (e.g., operational agents 1008).

Operational agents 1008 may include one or more computing engines that may include one or more nontransitory computer-readable mediums having stored thereon executable instructions operable to instruct a processor to provide operational functions. At an appropriate time, such as upon booting hardware platform 1000 or upon a command from operating system 1006 or a user or security administrator, a processor 1002 may retrieve a copy of the operational agent (or software portions thereof) from storage 1050 and load it into memory 1004. Processor 1002 may then iteratively execute the instructions of operational agents 1008 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, Python, Javascript, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 1000 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCOE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 1000 may be virtualized, in particular the processor(s) and memory. For example, a virtualized environment may run on OS 1006, or OS 1006 could be replaced with a hypervisor or virtual machine manager. In this configuration, a virtual machine running on hardware platform 1000 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 10 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

FIG. 11 is a block diagram of a NFV infrastructure 1100. NFV is an example of virtualization, and the virtualization infrastructure here can also be used to realize traditional VMs. Various functions described above may be realized as VMs, including various modules of cloud service 500 above.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1100. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 11, an NFV orchestrator 1101 may manage several VNFs 1112 running on an NFVI 1100. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1101 a valuable system resource. Note that NFV orchestrator 1101 may provide a browser-based or graphical configuration interface, and in some embodiments may be integrated with SDN orchestration functions.

Note that NFV orchestrator 1101 itself may be virtualized (rather than a special-purpose hardware appliance). NFV orchestrator 1101 may be integrated within an existing SDN system, wherein an operations support system (OSS) manages the SDN. This may interact with cloud resource management systems (e.g., OpenStack) to provide NFV orchestration. An NFVI 1100 may include the hardware, software, and other infrastructure to enable VNFs to run. This may include a hardware platform 1102 on which one or more VMs 1104 may run. For example, hardware platform 1102-1 in this example runs VMs 1104-1 and 1104-2. Hardware platform 1102-2 runs VMs 1104-3 and 1104-4. Each hardware platform 1102 may include a respective hypervisor 1120, virtual machine manager (VMM), or similar function, which may include and run on a native (bare metal) operating system, which may be minimal so as to consume very few resources. For example, hardware platform 1102-1 has hypervisor 1120-1, and hardware platform 1102-2 has hypervisor 1120-2.

Hardware platforms 1102 may be or comprise a rack or several racks of blade or slot servers (including, e.g., processors, memory, and storage), one or more data centers, other hardware resources distributed across one or more geographic locations, hardware switches, or network interfaces. An NFVI 1100 may also include the software architecture that enables hypervisors to run and be managed by NFV orchestrator 1101.

Running on NFVI 1100 are VMs 1104, each of which in this example is a VNF providing a virtual service appliance. Each VM 1104 in this example includes an instance of the Data Plane Development Kit (DPDK) 1116, a virtual operating system 1108, and an application providing the VNF 1112. For example, VM 1104-1 has virtual OS 1108-1, DPDK 1116-1, and VNF 1112-1. VM 1104-2 has virtual OS 1108-2, DPDK 1116-2, and VNF 1112-2. VM 1104-3 has virtual OS 1108-3, DPDK 1116-3, and VNF 1112-3. VM 1104-4 has virtual OS 1108-4, DPDK 1116-4, and VNF 1112-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 11 shows that a number of VNFs 1104 have been provisioned and exist within NFVI 1100. This FIGURE does not necessarily illustrate any relationship between the VNFs and the larger network, or the packet flows that NFVI 1100 may employ.

The illustrated DPDK instances 1116 provide a set of highly-optimized libraries for communicating across a virtual switch (vSwitch) 1122. Like VMs 1104, vSwitch 1122 is provisioned and allocated by a hypervisor 1120. The hypervisor uses a network interface to connect the hardware platform to the data center fabric (e.g., a host fabric interface (HFI)). This HFI may be shared by all VMs 1104 running on a hardware platform 1102. Thus, a vSwitch may be allocated to switch traffic between VMs 1104. The vSwitch may be a pure software vSwitch (e.g., a shared memory vSwitch), which may be optimized so that data are not moved between memory locations, but rather, the data may stay in one place, and pointers may be passed between VMs 1104 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1122 is illustrated, wherein vSwitch 1122 is shared between two or more physical hardware platforms 1102.

FIG. 12 is a block diagram of selected elements of a containerization infrastructure 1200. Like virtualization, containerization is a popular form of providing a guest infrastructure. Various functions described herein may be containerized, including various modules of cloud service 500 above.

Containerization infrastructure 1200 runs on a hardware platform such as containerized server 1204. Containerized server 1204 may provide processors, memory, one or more network interfaces, accelerators, and/or other hardware resources.

Running on containerized server 1204 is a shared kernel 1208. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1208 is main operating system 1212. Commonly, main operating system 1212 is a Unix or Linux-based operating system, although containerization infrastructure is also available for other types of systems, including Microsoft Windows systems and Macintosh systems. Running on top of main operating system 1212 is a containerization layer 1216. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1212 may also provide services 1218, which provide services and interprocess communication to userspace applications 1220.

Services 1218 and userspace applications 1220 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1212, they inherit the same file and resource access permissions as those provided by shared kernel 1208. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1204, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1204).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors-especially type 1, or “bare metal,” hypervisors-provide such near-native performance that this advantage may not always be realized.

In this example, containerized server 1204 hosts two containers, namely container 1230 and container 1240.

Container 1230 may include a minimal operating system 1232 that runs on top of shared kernel 1208. Note that a minimal operating system is provided as an illustrative example, and is not mandatory. In fact, container 1230 may perform as full an operating system as is necessary or desirable. Minimal operating system 1232 is used here as an example simply to illustrate that in common practice, the minimal operating system necessary to support the function of the container (which in common practice, is a single or monolithic function) is provided.

On top of minimal operating system 1232, container 1230 may provide one or more services 1234. Finally, on top of services 1234, container 1230 may also provide userspace applications 1236, as necessary.

Container 1240 may include a minimal operating system 1242 that runs on top of shared kernel 1208. Note that a minimal operating system is provided as an illustrative example, and is not mandatory. In fact, container 1240 may perform as full an operating system as is necessary or desirable. Minimal operating system 1242 is used here as an example simply to illustrate that in common practice, the minimal operating system necessary to support the function of the container (which in common practice, is a single or monolithic function) is provided.

On top of minimal operating system 1242, container 1240 may provide one or more services 1244. Finally, on top of services 1244, container 1240 may also provide userspace applications 1246, as necessary.

Using containerization layer 1216, containerized server 1204 may run discrete containers, each one providing the minimal operating system and/or services necessary to provide a particular function. For example, containerized server 1204 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

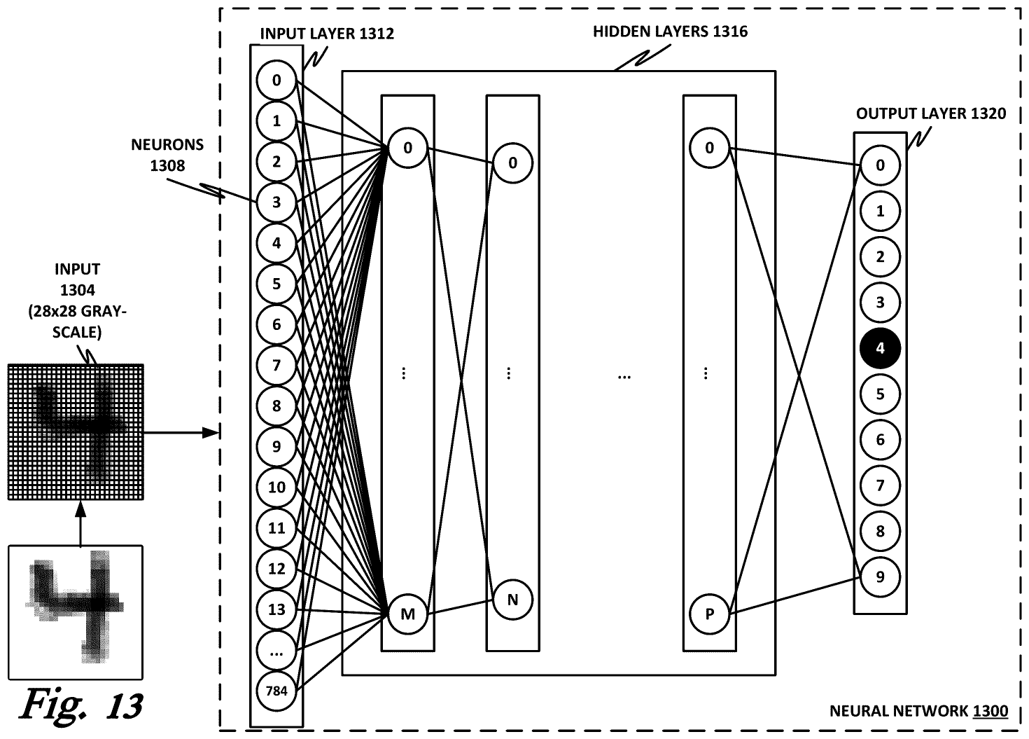

FIGS. 13-15 illustrate selected elements of an artificial intelligence system or architecture. In these FIGURES, an elementary neural network is used as a representative embodiment of an artificial intelligence or machine learning architecture or engine. This should be understood to be a nonlimiting example, and other machine learning or artificial intelligence architectures are available, including for example symbolic learning, robotics, computer vision, pattern recognition, statistical learning, speech recognition, natural language processing, deep learning, convolutional neural networks, recurrent neural networks, object recognition and/or others.

FIG. 13 illustrates machine learning according to a “textbook” problem with real-world applications. In this case, a neural network 1300 is tasked with recognizing characters. To simplify the description, neural network 1300 is tasked only with recognizing single digits in the range of o through 9. These are provided as an input image 1304. In this example, input image 1304 is a 28×28-pixel 8-bit grayscale image. In other words, input image 1304 is a square that is 28 pixels wide and 28 pixels high. Each pixel has a value between o and 255, with o representing white or no color, and 255 representing black or full color, with values in between representing various shades of gray. This provides a straightforward problem space to illustrate the operative principles of a neural network. Only selected elements of neural network 1300 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other artificial intelligence architecture, to meet the demands of a particular problem. Indeed, the architecture here is sometimes referred to as the “Hello World” problem of machine learning, and is provided as but one example of how the machine learning or artificial intelligence functions of the present specification could be implemented.

In this case, neural network 1300 includes an input layer 1312 and an output layer 1320. In principle, input layer 1312 receives an input such as input image 1304, and at output layer 1320, neural network 1300 “lights up” a perceptron that indicates which character neural network 1300 thinks is represented by input image 1304.

Between input layer 1312 and output layer 1320 are some number of hidden layers 1316. The number of hidden layers 1316 will depend on the problem to be solved, the available compute resources, and other design factors. In general, the more hidden layers 1316, and the more neurons per hidden layer, the more accurate the neural network 1300 may become. However, adding hidden layers and neurons also increases the complexity of the neural network, and its demand on compute resources. Thus, some design skill is required to determine the appropriate number of hidden layers 1316, and how many neurons are to be represented in each hidden layer 1316.

Input layer 1312 includes, in this example, 784 “neurons” 1308. Each neuron of input layer 1312 receives information from a single pixel of input image 1304. Because input image 1304 is a 28×28 grayscale image, it has 784 pixels. Thus, each neuron in input layer 1312 holds 8 bits of information, taken from a pixel of input layer 1304. This 8-bit value is the “activation” value for that neuron.

Each neuron in input layer 1312 has a connection to each neuron in the first hidden layer in the network. In this example, the first hidden layer has neurons labeled o through M. Each of the M+1 neurons is connected to all 784 neurons in input layer 1312. Each neuron in hidden layer 1316 includes a kernel or transfer function, which is described in greater detail below. The kernel or transfer function determines how much “weight” to assign each connection from input layer 1312. In other words, a neuron in hidden layer 1316 may think that some pixels are more important to its function than other pixels. Based on this transfer function, each neuron computes an activation value for itself, which may be for example a decimal number between o and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from o to N. As in the previous layer, each neuron has a transfer function that assigns a particular weight to each of its M+1 connections and computes its own activation value. In this manner, values are propagated along hidden layers 1316, until they reach the last layer, which has P+1 neurons labeled o through P. Each of these P+1 neurons has a connection to each neuron in output layer 1320. Output layer 1320 includes a number of neurons known as perceptrons that compute an activation value based on their weighted connections to each neuron in the last hidden layer 1316. The final activation value computed at output layer 1320 may be thought of as a “probability” that input image 1304 is the value represented by the perceptron. For example, if neural network 1300 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to o.

Conceptually, neurons in the hidden layers 1316 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between o and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (o) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

$${a}_{0}^{( 1 )} = σ ( {w}_{0} {a}_{0}^{( 0 )} + {w}_{1} {a}_{1}^{( 0 )} + … {w}_{783} {a}_{783}^{( 0 )} + b )$$

In this case, it is assumed that layer o (input layer 1312) has 784 neurons. Where the previous layer has “n” neurons, the function can be generalized as:

$${a}_{0}^{( 1 )} = σ ( {w}_{0} {a}_{0}^{( 0 )} + {w}_{1} {a}_{1}^{( 0 )} + … {w}_{n} {a}_{n}^{( 0 )} + b )$$

A similar function is used to compute the activation value of each neuron in layer 1 (the first hidden layer), weighted with that neuron's strength of connections to each neuron in layer o, and biased with some threshold value. As discussed above, the sigmoid function shown here is intended to stand for any function that normalizes the output to a value between o and 1.

The full transfer function for layer 1 (with k neurons in layer 1) may be written in matrix notation as:

$${a}^{( 1 )} = σ ( [ \begin{matrix}{w}_{0 , 0} & … & {w}_{0 , n} \\ ⋮ & ⋱ & ⋮ \\ {w}_{( k , 0 )} & … & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

$${a}^{( 1 )} = σ ( W {a}^{( 0 )} + b )$$

Neural connections and activation values are propagated throughout the hidden layers 1316 of the network in this way, until the network reaches output layer 1320. At output layer 1320, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 1320 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

Wherein w is a vector containing all of the parameters (weights and biases) in the network. The minimum (absolute and/or local) can then be represented as a trivial calculus problem, namely:

$$\frac{d C}{d w} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

$$- ∇ C ( w )$$

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolutel minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

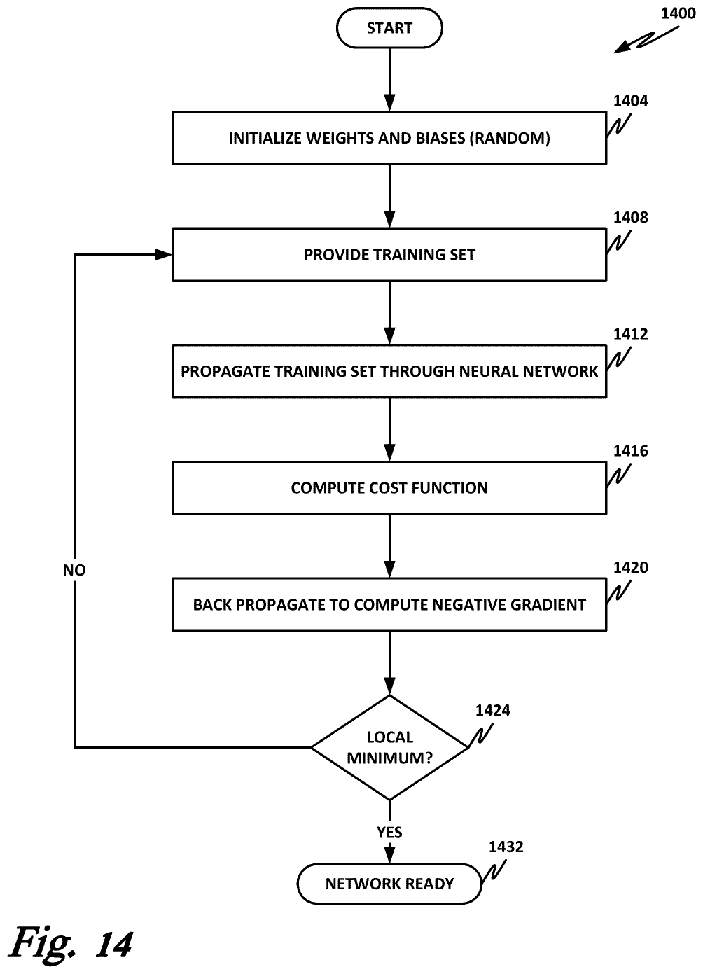

FIG. 14 is a flowchart of a method 1400. Method 1400 may be used to train a neural network, such as neural network 1300 of FIG. 13.

In block 1404, the network is initialized. Initially, neural network 1300 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between o and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1408, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1408, the initial training set is provided to the neural network. Alternatively, the full training set could be used in each iteration.

In block 1412, the training data are propagated through the neural network. Because the initial values are random, and are therefore essentially garbage, it is expected that the output will also be a garbage value. In other words, if neural network 1300 of FIG. 13 has not been trained, when input image 1304 is fed into the neural network, it is not expected with the first training set that output layer 1320 will light up perceptron 4. Rather, the perceptrons may have values that are all over the map, with no clear winner, and with very little relation to the number 4.

In block 1416, a cost function is computed as described above. For example, in neural network 1300, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1420, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1424, the system determines whether it has reached a local minimum (e.g., whether the gradient has reached o within the threshold). If the local minimum has not been reached, then the neural network has not been adequately trained, and control returns to block 1408 with a new training set. The training sequence continues until, in block 1424, a local minimum has been reached.

Now that a local minimum has been reached and the corrections have been back-propagated, in block 1432, the neural network is ready.

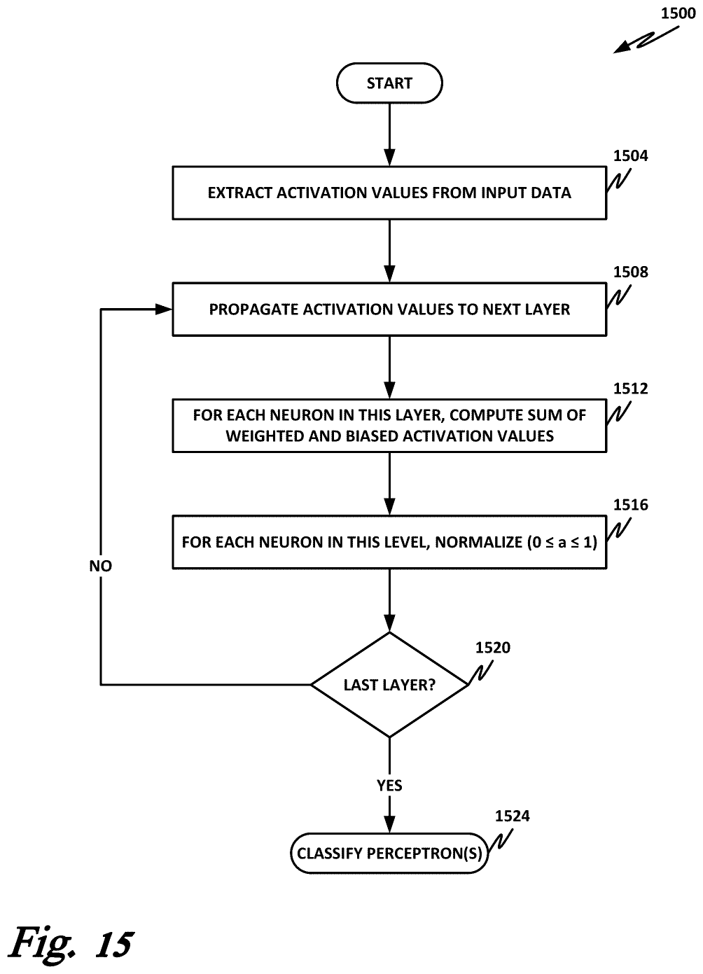

FIG. 15 is a flowchart of a method 1500. Method 1500 illustrates a method of using a neural network, such as network 1300 of FIG. 13, to classify an object.

In block 1504, the network extracts the activation values from the input data. For example, in the example of FIG. 13, each pixel in input image 1304 is assigned as an activation value to a neuron 1308 in input layer 1312.

In block 1508, the network propagates the activation values from the current layer to the next layer in the neural network. For example, after activation values have been extracted from the input image, those values may be propagated to the first hidden layer of the network.

In block 1512, for each neuron in the current layer, the neuron computes a sum of weighted and biased activation values received from each neuron in the previous layer. For example, in the illustration of FIG. 13, neuron o of the first hidden layer is connected to each neuron in input layer 1312. A sum of weighted values is computed from those activation values, and a bias is applied.

In block 1516, for each neuron in the current layer, the network normalizes the activation values by applying a function such as sigmoid, ReLU, or some other function.

In decision block 1520, the network determines whether it has reached the last layer in the network. If this is not the last layer, then control passes back to block 1508, where the activation values in this layer are propagated to the next layer.

Returning to decision block 1520, If the network is at the last layer, then the neurons in this layer are perceptrons that provide final output values for the object. In terminal 1524, the perceptrons are classified and used as output values.

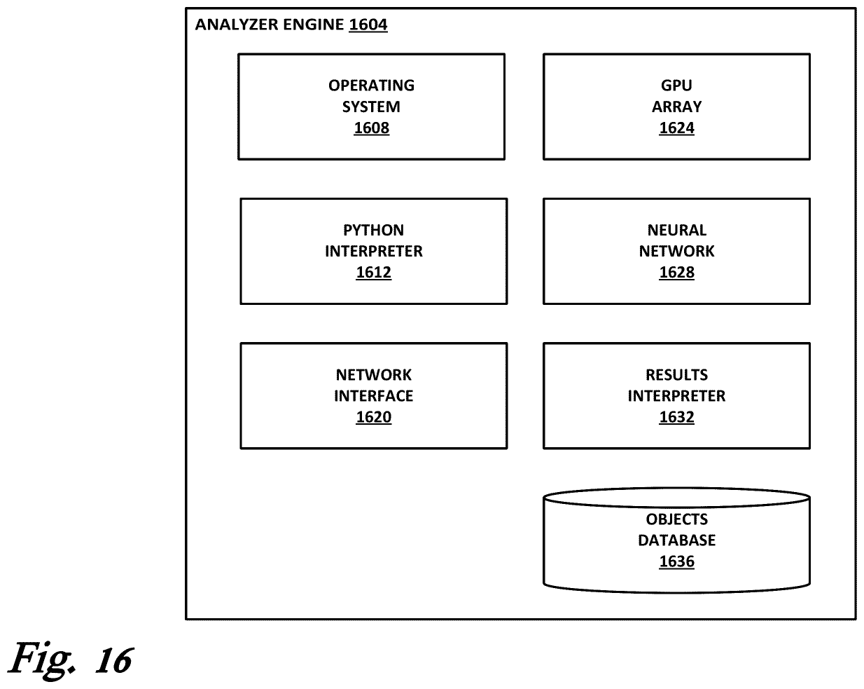

FIG. 16 is a block diagram illustrating selected elements of an analyzer engine 1604. Analyzer engine 1604 may be configured to provide analysis services, such as via a neural network. FIG. 16 illustrates a platform for providing analysis services. Analysis, such as neural analysis and other machine learning models, may be used in some embodiments to provide one or more features of the present disclosure.

Note that analyzer engine 1604 is illustrated here as a single modular object, but in some cases, different aspects of analyzer engine 1604 could be provided by separate hardware, or by separate guests (e.g., VMs or containers) on a hardware system.

Analyzer engine 1604 includes an operating system 1608. Commonly, operating system 1608 is a Linux operating system, although other operating systems, such as Microsoft Windows, Mac OS X, UNIX, or similar could be used. Analyzer engine 1604 also includes a Python interpreter 1612, which can be used to run Python programs. A Python module known as Numerical Python (NumPy) is often used for neural network analysis. Although this is a popular choice, other non-Python or non-NumPy systems could also be used. For example, the neural network could be implemented in Matrix Laboratory (MATLAB), C, C++, Fortran, R, or some other compiled or interpreted computer language.

GPU array 1624 may include an array of graphics processing units that may be used to carry out the neural network functions of neural network 1628. Note that GPU arrays are a popular choice for this kind of processing, but neural networks can also be implemented in CPUs, or in ASICs or FPGAs that are specially designed to implement the neural network.

Neural network 1628 includes the actual code for carrying out the neural network, and as mentioned above, is commonly programmed in Python.

Results interpreter 1632 may include logic separate from the neural network functions that can be used to operate on the outputs of the neural network to assign the object for particular classification, perform additional analysis, and/or provide a recommended remedial action.

Objects database 1636 may include a database of known malware objects and their classifications. Neural network 1628 may initially be trained on objects within objects database 1636, and as new objects are identified, objects database 1636 may be updated with the results of additional neural network analysis.

Once final results have been obtained, the results may be sent to an appropriate destination via network interface 1620.

The foregoing outlines features of several embodiments so that those skilled in the art may better understand various aspects of the present disclosure. The foregoing detailed description sets forth examples of apparatuses, methods, and systems relating to a system for providing an AI assistant for investigative questioning, in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-81. (canceled)

82. One or more tangible, nontransitory computer-readable storage media having stored thereon executable instructions to instruct one or more processors to:
based on known information about an event under investigation, access a generative artificial intelligence (GAI) trained to generate investigative question prompts to guide a human investigator, wherein the investigative question prompts are to assist the human investigator in asking probative and open-ended questions of a human participant in or witness to the event under investigation; and
interactively display the investigative question prompts to the human investigator during the course of an interview.

83. The one or more tangible, nontransitory computer-readable storage media of claim 82, wherein the event under investigation is an insurance event.

84. The one or more tangible, nontransitory computer-readable storage media of claim 83, wherein the insurance event comprises an automobile accident.

85. The one or more tangible, nontransitory computer-readable storage media of claim 83, wherein the insurance event comprises a worksite accident.

86. The one or more tangible, nontransitory computer-readable storage media of claim 83, wherein the insurance event comprises a retail loss.

87. The one or more tangible, nontransitory computer-readable storage media of claim 83, wherein the insurance event comprises a structural loss from a natural disaster or social unrest.

88. The one or more tangible, nontransitory computer-readable storage media of claim 82, wherein the instructions are further to incorporate geographic information system (GIS) knowledge into the investigative question prompts.

89. The one or more tangible, nontransitory computer-readable storage media of claim 82, wherein the instructions are further to incorporate weather condition knowledge into the investigative question prompts.

90. The one or more tangible, nontransitory computer-readable storage media of claim 82, wherein the instructions are further to incorporate traffic condition knowledge into the investigative question prompts.

91. The one or more tangible, nontransitory computer-readable storage media of claim 82, wherein the instructions are further to operate an AI system to create a digest of previous information about the event under investigation, and incorporate the digest into the investigative question prompts.

92. The one or more tangible, nontransitory computer-readable storage media of claim 82, wherein the instructions are further to provide an interactive display for the human investigator.

93. The one or more tangible, nontransitory computer-readable storage media of claim 92, wherein the interactive display includes a map of a situs of the event under investigation, wherein the map is based on geographic information system (GIS) data.

94. The one or more tangible, nontransitory computer-readable storage media of claim 92, wherein the interactive display includes images with a human markup capability.

95. The one or more tangible, nontransitory computer-readable storage media of claim 82, wherein the instructions are further to transcribe a verbal conversation between the human investigator and the human participant, and adjust the investigative question prompts based on the transcribing.

96. The one or more tangible, nontransitory computer-readable storage media of claim 82, wherein the instructions are further to recognize language and/or non-language indicia of sentiment, and provide a transcript that includes the indicia of sentiment.

97. The one or more tangible, nontransitory computer-readable storage media of claim 82, wherein the GAI comprises a large language model (LLM) or generative pre-trained transformer (GPT).

98. A computer-implemented method, comprising:
based on known information about an event under investigation, accessing a generative artificial intelligence (GAI) trained to generate investigative question prompts to guide a human investigator, wherein the investigative question prompts are to assist the human investigator in asking probative and open-ended questions of a human participant in or witness to the event under investigation; and
interactively displaying, on a computer display, the investigative question prompts to the human investigator during the course of an interview.

99. The computer-implemented method of claim 98, wherein the event under investigation is an insurance event.

100. A field device for an investigator, comprising:
a hardware platform comprising a processor circuit, a memory, and an interactive display device; and
instructions encoded within the memory to instruct the processor circuit to:
based on known information about an event under investigation, access a generative artificial intelligence (GAI) trained to generate investigative question prompts to guide a human investigator, wherein the investigative question prompts are to assist the human investigator in asking probative and open-ended questions of a human participant in or witness to the event under investigation; and
display, via the interactive display device, the investigative question prompts to the human investigator during the course of an interview.

101. The field device of claim 100, wherein the event under investigation is an insurance event.
